(19) United States
(12) Patent Application Publication
(10) Pub. No.: US 2026/0177840 A1
(43) Pub. Date: Jun. 25, 2026

(54) LIGHT FIELD DISPLAY SYSTEM

(71) Applicant: Avalon Holographics Inc., St. John’s (CA)

(72) Inventor: Kyle Willick, Goulds (CA)

(21) Appl. No.: 19/425,427

(22) Filed: Dec. 18, 2025

Related U.S. Application Data
(60) Provisional application No. 63/735,940, filed on Dec. 19, 2024.

(51) Int. Cl. G02B 30/10

(52) U.S. Cl. CPC G02B 30/10

(57) ABSTRACT

A light field display system comprises an array of light field projector devices capable of shifting the ray path of light rays at a redirection angle based on a distance of the light ray from the hogel center ray, to produce a seamless light field image. Each light field projector device comprises a projection optical system comprising a light source and a light field optical system to create a plurality of hogels, each hogel having an associated light field image. The output of each of the plurality of hogels in each light field projector device may be redirected according to the redirection angle toward the outer edge of each projector body to enable seamless tiling of the projector devices in the light field display system to create a seamless light field.

### CROSS-REFERENCE TO RELATED APPLICATIONS

This application claims priority to U.S. patent application Ser. No. 63/735,940 filed 19 Dec. 2024, which is hereby incorporated by reference herein in its entirety.

### FIELD OF THE INVENTION

The present disclosure relates to light field projector devices and light field display systems for creating a light field display to minimize pixel size, and optimize assembly, alignment, and display viewing parameters. The presently described light field projector device and system can be used in a light field display system to provide a light field suitable for 3D display and can be used for multiple-view, autostereoscopic, and high-angular resolution, light field display viewable with both horizontal and vertical parallax.

### BACKGROUND OF THE INVENTION

A light field display system is an advanced visual technology designed to recreate a complete light field, encompassing both the spatial and angular properties of light and providing an engaging three dimensional (3D) visual experience. Light field displays enable the presentation of multiple views, allowing users to perceive distinct images in each eye. This allows viewers to perceive depth, parallax, and realistic three-dimensional images without requiring special glasses or headsets. The system can achieve this by utilizing arrays of light-emitting elements, such as hogels or microlenses, to project light rays at specific angles, replicating how light interacts with real-world objects to create a light field display. By providing continuous light information from multiple viewpoints, a light field display system can enable dynamic perspective changes as viewers move around the display. Light field display systems rely on advanced optical and computational techniques to capture, process, and emit the complex light fields necessary for producing highly realistic and engaging visual experiences. Light field display systems are particularly valuable in applications like holography, medical imaging, augmented and virtual reality, and immersive entertainment, where high-fidelity and interactive 3D visualization are essential.

By offering a broader visual perspective, 3D displays enhance the user's ability to interpret images. However, achieving a truly immersive light field display requires high pixel density, minimal angular separation between views, and an expansive viewing angle. For optimal performance, users should experience seamless transitions between viewing zones while retaining distinct and perceivable images across adjacent views. Certain 3D display technologies utilize polarized light, requiring specialized glasses, while others employ direct projection methods to generate single-dimension parallax effects.

Projector-based light field displays typically incorporate one or more projectors and rely on complex optical systems to generate a comprehensible light field. Producing a high-definition light field display demands a large number of pixels with high pixel density, often necessitating additional projectors in conjunction with multiple optical components. This results in systems that are not only large but also expensive and challenging to scale effectively with substantial power requirements. In one example of a light-field display device, U.S. Patent Application Publication No. 2018/0101018 to Chung et al. describes a light field display device comprising a screen, a grating pixel array, and an image generator. The grating pixel array is configured to diffract the light, including the 3D image information, in multiple directions, forming an output 3D light field image. The grating pixel array adds to the bulk of the projector display device.

Achieving seamless transitions between adjacent projector display sections presents technical difficulties in multi-unit display arrangements. In particular, the boundaries where separate units meet can exhibit misalignment, color differences, or brightness variations that disrupt the visual continuity of the light field. Maintaining consistent image quality across unit boundaries requires precise control over the optical paths and emission characteristics of each projector. Conventional approaches often rely on mechanical positioning and electronic calibration, which may have limited effectiveness in eliminating visible seams. Accommodating diverse spatial configurations, such as non-planar surfaces or irregular geometries, introduces additional complexity. The physical constraints of projector housings and emission apertures can limit how closely units can be positioned, potentially leaving gaps in coverage or creating overlapping regions that require blending.

Current methods for aligning and calibrating multiple projection sources typically involve adjusting the position, orientation, and output characteristics of each unit. Mechanical alignment systems can position projectors relative to the display surface, while electronic calibration adjusts color, brightness, and geometric distortion. These approaches can require extensive setup time and ongoing maintenance to preserve alignment as environmental conditions change. Adapting display systems to non-standard installation geometries can be constrained by the fixed optical properties of conventional projectors. Trade-offs between system complexity and visual performance often arise, as more sophisticated alignment mechanisms increase cost and installation difficulty while potentially improving the seamlessness of the combined display.

Improved display configurations that support various installation scenarios would address limitations in current multi-unit projector systems. Applications can also require projectors to be arranged in different orientations and spatial relationships to accommodate available space and viewing requirements. Simplified integration of multiple units with reduced visible artifacts would reduce setup time and improve the viewing experience. Alternative approaches to addressing tiling challenges could provide options beyond purely mechanical or electronic solutions. Methods that facilitate seamless boundaries between adjacent display units without requiring extreme precision in physical positioning would be beneficial for a range of display applications.

In an example of a light projection device, U.S. Pat. No. 9,383,591 to Pasolini describes a pico-projector device featuring a light source for producing a light beam, a mirror mechanism for directing the beam onto a display surface, and a driving circuit for stabilizing the projected image via compensation signals. While this device generates conventional projected images and compensates for motion through a gyroscope, it would require additional optical elements and processing capabilities to produce a full 3D light field display.

In another example of a light-field display device, U.S. Pat. No. 11,493,836 to Peckham et al. discloses a light field projector device which outputs a light field. The projector has a projector base with a projection optical system configured to output light rays to form a projected image, and a collimating optical system configured for collimation of the projected image light rays to form a second projected image which is directed to a display optical system to produce a light field image. The light field projector devices may be tiled together to form a larger light field display system or projector array. There remains a need for an advanced light field projector device capable of delivering a full-parallax light field display.

This background information is provided for the purpose of making known information believed by the applicant to be of possible relevance to the present invention. No admission is necessarily intended, nor should be construed, that any of the preceding information constitutes prior art against the present invention.

### BRIEF SUMMARY

An object of the present invention is to provide a light field display system comprising an array of light field projector devices where the projector device shifts the ray path of light rays at a redirection angle based on a distance of the light ray from the hogel center ray, shifting the apparent hogel center of each microlens to produce a seamless light field image.

In an aspect there is provided a light field projector device comprising: a light source; a projection optical system to receive light from the light source and direct the light into a single ray path; and a light field optical system comprising: a pixel forming device to receive light from the projection optical system and convert the light into a pixel array to create a plurality of elemental images, each elemental image comprising a plurality of light rays; and a hogel defining element for receiving the light rays from each of the plurality of elemental images, defining a plurality of hogels, each hogel having an associated elemental image, and creating a light field.

In another embodiment, the light source comprises a plurality of light emitting diodes.

In another embodiment, the plurality of light emitting diodes emits red, green or blue light.

In another embodiment, the light field projector device further comprises a plurality of light sources, wherein at least one of the plurality of light sources comprises more than one LED of at least two different colors.

In another embodiment, the pixel forming device comprises one of a Liquid Crystal Display (LCD), Organic Light-Emitting Diode (OLED), microLED, Digital Micromirror Device (DMD), Liquid Crystal on Silicon (LCoS), and a quantum dot-based panel.

In another embodiment, the hogel defining element is a microlens array, a lenticular lens, a metalens, or a combination thereof.

In another embodiment, at least one microlens in the microlens array has unique properties depending on its position in the microlens array.

In another embodiment, the light field projector device further comprises, between the pixel forming device and the display lens, a reprojection optical component for receiving the plurality of elemental images; refocusing the plurality of light rays from each of the plurality of elemental images; and redirecting each of the plurality of light rays at a redirection angle.

In another embodiment, the redirection angle is uniform for the plurality of light rays within a single elemental image.

In another embodiment, the redirection angle is unique to each elemental image.

In another embodiment, the reprojection optical component is metalens, at least one lens, or a combination thereof.

In another embodiment, each of the plurality of hogels has an apparent hogel center shifted outward an offset distance from an actual hogel center to the edge of the display lens based on a location of the hogel relative to a center of the light field projector device.

In another embodiment, the offset distance increases as a function of the redirection angle.

In another embodiment, the light field projector device further comprises a hogel position shifting optical element positioned downstream from the hogel defining element to receive the plurality of hogels from the hogel defining element and configured to further shift the apparent hogel center of each hogel as perceived by a viewer to create a light field.

In another embodiment, the hogel position shifting optical element comprises one or more lenses.

In another aspect there is provided a light field projector device comprising: a light source; a projection optical system to receive light from the light source and direct the light into a single ray path; and a light field optical system comprising: a pixel forming device to generate light in a pixel array creating a plurality of elemental images, each elemental image comprising a plurality of light rays; a reprojection optical component for: receiving the plurality of elemental images; refocusing the plurality of light rays from each elemental image; and redirecting each of the plurality of light rays at a redirection angle; and a display lens for receiving the plurality of redirected light rays and defining a plurality of hogels, each of the plurality of hogels having an associated elemental image, an actual hogel center and an apparent hogel center, and creating a light field.

In another aspect there is provided a method for generating a light field image, the method comprising: creating a light field image at a plurality of light field projector devices by: generating light with a light source; directing the light from the light source into a single ray path; pixelating the light at a pixel forming device to convert the light into a pixel array comprising a plurality of elemental images, each elemental image comprising a plurality of light rays; refocusing the plurality of light rays from each elemental image; redirecting each of the plurality of light rays at a redirection angle; and receiving the plurality of redirected light rays at a display lens to define a plurality of hogels, each hogel having an associated elemental image and an actual hogel center, and creating a light field; and tiling the light fields created by the plurality of light field projectors to provide a tiled light field image.

In another embodiment, the redirection angle is larger for hogels closer to an edge of the display lens.

In another embodiment, larger redirection angles for hogels closer to the edge of the display lens create an apparent hogel center, shifted outward an offset distance from the actual hogel center to the edge of each projector device, enabling controlled magnification of the light emitted from each projector which forms the light field to generate a seamless tiled light field image between the light field projector devices.

In another aspect there is provided a light field projector device comprising: a light source;

a projection optical system to receive light from the light source and direct the light into a single ray path; and a light field optical system comprising: a pixel forming device to receive light from the projection optical system and convert the light into a pixel array to create a plurality of elemental images; and a hogel defining element for creating a plurality of hogels from the plurality of elemental images, each hogel having an associated elemental image, and creating a light field.

In another embodiment, the hogel defining element comprises a microlens array, a metalens, at least one lens, or a combination thereof.

In another embodiment, each of the plurality of hogels has an apparent hogel center shifted outward an offset distance from an actual hogel center toward an edge of the hogel defining element.

In another embodiment, the hogel defining element enables seamless tiling between multiple light field projector devices by generating apparent hogel centers to cover mechanical gaps between projector devices.

In another aspect there is provided a method for creating a light field display comprising: generating elemental images by converting light rays into a pixel array at a pixel forming device; creating hogels from the elemental images using a hogel defining element, each hogel having an actual hogel center; and for at least some of the hogels, shifting an apparent hogel center outward an offset distance from the actual hogel center to the edge of the hogel defining element.

In another embodiment, the method further comprises maintaining substantially normal light input to the hogel defining element while achieving apparent hogel centers shifted outward an offset distance from the actual hogel center to the edge of the hogel defining element.

In another aspect there is provided a light field display system comprising: a plurality of tiled light field projector devices, each of the plurality of light field projector devices comprising: a light source; a projection optical system to receive light from the light source and direct the light into a single ray path; and a light field optical system comprising: a pixel forming device to receive light from the projection optical system and convert the light into a pixel array to create a plurality of elemental images, each elemental image comprising a plurality of light rays; and a hogel defining element for receiving the light rays from each of the plurality of elemental images, defining a plurality of hogels, each hogel having an associated elemental image, and creating a light field.

In another embodiment, the plurality of light field projector devices are tiled to form one of an asymmetric wall display, a curved wall display, a tabletop display, a horizontally mounted display unit, a tiled floor display, and a tiled wall with floor display.

In another embodiment, the plurality of light field projector devices are positioned at varying angles relative to each other to form the curved wall display.

In another embodiment, the light field display system further comprises a mounting system configured to arrange the plurality of light field projector devices in multiple display configurations.

In another embodiment, the multiple display configurations comprise one or more of asymmetric arrangements, curved arrangements, varying orientations, floor configurations, and combined wall-floor configurations.

In another embodiment, the mounting system allows reconfiguration between different display types without modification of individual projector devices.

In another aspect there is provided a method for creating a light field display comprising: providing a plurality of light field projector devices, each projector device comprising: a light source; a pixel forming device to generate a plurality of elemental images; and a hogel defining element for receiving light from the pixel forming device and creating hogels from the elemental images, each elemental image comprising a plurality of light rays; arranging the plurality of light field projector devices in a tiled configuration; and calibrating the hogel defining elements to provide seamless tiling across the tiled configuration.

In another embodiment, the hogel defining element comprises a display lens.

In another embodiment, the hogel defining element redirects the plurality of light rays from each elemental image at a redirection angle to generate hogels having an apparent hogel center offset from an actual hogel center.

In another embodiment, the apparent hogel center is shifted outward an offset distance from the actual hogel center toward an edge of the hogel defining element.

In another embodiment, the redirection angle varies based on a position of the hogel within the hogel defining element.

In another embodiment, the tiled configuration is one of a symmetric wall configuration, an asymmetric wall configuration, a curved wall configuration, a tabletop configuration, a horizontal mounting configuration, a tiled floor configuration, and a tiled wall with floor configuration.

In an aspect of the present invention there is provided a light field projector device comprising: a light source; a projection optical system to receive light from the light source and direct the light into a single ray path; a pixel forming device to receive light from the projection optical system and convert the light into a pixel array to create a plurality of elemental images, each elemental image defining a hogel; a reprojection optical component for: receiving the plurality of elemental images; refocusing the plurality of light rays from each elemental image; and redirecting each of the plurality of light rays at a redirection angle; and a display lens for receiving the plurality of redirected light rays and creating a light field.

In an embodiment, each of the plurality of light rays in an elemental image is redirected at a different redirection angle by the reprojection optical component.

In another embodiment, the light source is a light emitting diode.

In another embodiment, the light emitting diode emits red, green or blue light.

In another embodiment, the light field projector device further comprises a plurality of light sources, wherein at least one of the plurality of light sources comprises more than one LED of at least two different colors.

In another embodiment, the pixel forming device comprises one of a Liquid Crystal Display (LCD), Organic Light-Emitting Diode (OLED), microLED, Digital Micromirror Device (DMD), Liquid Crystal on Silicon (LCoS), and a quantum dot-based panel.

In another embodiment, the reprojection optical component is metalens, at least one lens, or a combination thereof.

In another embodiment, the redirection angle is larger for hogels closer to the edge of the display lens.

In another embodiment, the display lens is a microlens array or lenticular lens.

In another embodiment, each microlens in the microlens array is a hogel in the light field.

In another embodiment, the microlenses in the microlens array have different properties depending on their position in the array.

In another aspect there is provided a light field projector device comprising: a pixel forming device to generate light in a pixel array creating a plurality of elemental images, each elemental image comprising a plurality of light rays; a reprojection optical component for: receiving the plurality of elemental images; refocusing the plurality of light rays from each elemental image; and redirecting each of the plurality of light rays at a redirection angle; and a display lens for receiving the plurality of redirected light rays and creating a light field.

In another aspect there is provided a light field display system comprising: a plurality of light field projector devices arranged in an array, each projector device comprising: a light source; a projection optical system comprising at least one lens to receive light from the light source and direct the light into a single ray path; a pixel forming device to receive light from the projection optical system and convert the light into a pixel array to create a plurality of elemental images, each elemental image comprising a plurality of light rays; a reprojection optical component for: receiving the plurality of elemental images; refocusing the plurality of light rays from each elemental image; and redirecting each of the plurality of light rays at a redirection angle, where each of the plurality of light rays in an elemental image is redirected at a different redirection angle; and a display lens for receiving the plurality of redirected light rays and creating a light field.

In an embodiment, the system further comprises a housing for holding in place the plurality of light field projector devices.

In another aspect there is provided a method for generating a light field image, the method comprising: creating a light field image at a plurality of light field projector devices by: generating light with a light source; directing light from the light source into a single ray path; pixelating light at a pixel forming device to convert the light into a pixel array comprising a plurality of hogels, each hogel comprising at least one elemental image; refocusing a plurality of light rays from each elemental image; redirecting each of the plurality of light rays at a redirection angle; receiving the plurality of redirected light rays at a display lens to create a light field; and tiling the light fields created from the plurality of light field projectors to provide a tiled light field image.

In an embodiment, the redirection angle is larger for hogels closer to the edge of the display lens.

In another embodiment, larger redirection angles for hogels closer to the edge of the display lens provide an optical shift of an apparent hogel point outward to the edge of each projector device, enabling controlled magnification of the light emitted from each projector which forms the light field to generate a seamless tiled light field image between the light field projector devices.

In another aspect there is provided a calibration method for a light field display system comprising an array of light field projector devices, the method comprising: calculating a specified white point value for each light field projector device by characterizing a projector output for each light field projector device by executing a characterization operation for each color of a defined color range for the light field display; generating a calibration file related to the specified white point values for each light field projector device in the light field display; and applying the calibration file to each projector to produce a uniform output.

In an embodiment, the calibration file comprises projector alignment settings, angular light ray distribution corrections, brightness and color adjustments, and lens distortion parameters.

In another embodiment, applying the calibration file alters the LED voltage, current, and mixing ratio of the light field projector device.

In another embodiment, the uniform output is color uniformity.

In another embodiment, the uniform output is measured using calibrated imaging device such as a photometer, colorimeter, or Digital Single-Lens Reflex Camera (DSLR).

In another aspect there is provided a light field display system comprising: a plurality of light field projector devices arranged in an array, each projector device comprising: a pixel forming device to generate light into a pixel array to create a plurality of elemental images, each elemental image comprising a plurality of light rays defining a hogel; a reprojection optical component for: receiving the plurality of elemental images; refocusing the plurality of light rays from each elemental image; and redirecting each of the plurality of light rays at a redirection angle, where each of the plurality of light rays in an elemental image is redirected at a different redirection angle; and

a display lens for receiving the plurality of redirected light rays and creating a light field.

Embodiments of the present invention as recited herein may be combined in any combination or permutation.

### BRIEF DESCRIPTION OF THE DRAWINGS

For a better understanding of the present invention, as well as other aspects and further features thereof, reference is made to the following description which is to be used in conjunction with the accompanying figures which illustrate embodiments or aspects of the invention.

FIG. 1 is a side view of a light field projection system according to the prior art.

FIG. 2 is a schematic of a light field projector device according to the prior art.

FIG. 3 is a cross-sectional view of a light field projector device.

FIG. 4 is a cross-sectional view of an example light field optical system with a microlens array.

FIG. 5 is a cross-sectional view of an example light field projector device showing projection and light field optical systems.

FIG. 6 is a cross-sectional view showing an example light field optical system with a reprojection optical component and microlens array.

FIG. 7 is a cross-sectional view of an example light field projector device with a hogel position shifting optical element.

FIG. 8 is a cross-sectional view of an example light field optical system with a reprojection optical component and hogel position shifting optical element.

FIG. 9 is a cross-sectional view of an example light field projector device with a projection optical system and light field optical system with hogel defining element.

FIG. 10 is a cross-sectional view showing of an example light field optical system with hogel defining element creating hogels with offset apparent hogel centers.

FIG. 11 is a side cross-sectional view showing an example light field projector array having a mechanical gap between projectors.

FIG. 12A is an isometric view of a pixel forming device and a reprojection optical component as per the present disclosure.

FIG. 12B is a cross-sectional view of a single pixel beam emitted from a pixel forming device and received by a reprojection optical component to shift the ray path of the beam received by a display lens.

FIG. 13 is a flow diagram of an example light field display calibration method.

FIG. 14 is an isometric view of an embodiment of a light field projector device.

FIG. 15 is an isometric view of an embodiment of a light field display system having a light field projector array comprising 3×4 tiled light field projector devices.

FIG. 16 is an isometric view showing a viewer positioned in front of a light field display system.

FIG. 17 is an isometric view showing a light field display system comprising an array of light field projector devices arranged to form a tiled wall.

FIG. 18 is an isometric view showing a light field display system comprising a tiled wall and a viewer positioned in front of the display.

FIG. 19 is an isometric view showing a light field display system comprising a tiled wall display and a tiled floor display.

FIG. 20 is an isometric view showing a horizontally curved wall light field display system with a viewer positioned in front of the display.

FIG. 21 is an isometric view showing a vertically curved wall light field display system with a vertical overhang and a viewer positioned in front of the display.

FIG. 22 is an isometric view showing a tabletop light field display system with a viewer positioned adjacent to the display.

FIG. 23 is an isometric view showing a tiled floor light field display system with a viewer standing on the display surface.

FIG. 24 is a flow diagram showing a method for creating a light field display.

### DETAILED DESCRIPTION

Various features of the invention will become apparent from the following detailed description taken together with the illustrations in the Figures. The design parameters, design method, construction, and use of the presently light field display system, light field projector devices, and structures disclosed herein are described with reference to various examples representing embodiments which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope of the invention. Working examples provided herein are considered to be non-limiting and merely for purposes of illustration.

Unless defined otherwise, all technical and scientific terms used herein have the same meaning as commonly understood by one of ordinary skill in the art to which this invention belongs.

As used herein, the term “calibration file” refers to a digital file that contains data and parameters used to correct, align, or optimize the performance of a system or device. A calibration file can serve as a reference for ensuring the system operates within its intended specifications by compensating for inaccuracies, variations, or environmental factors that might affect performance. In the context of light field displays or optical systems, a calibration file may include information such as projector alignment settings, angular light ray distribution corrections, brightness and color adjustments, and lens distortion parameters. This data allows the system to adjust its operation to achieve consistent and accurate output. For example, in a tiled light field display, the calibration file can store the precise spatial and angular alignment of each projector, compensating for mechanical gaps, overlaps, or misalignments to ensure a seamless light field image. Calibration files are typically generated during an initial setup or recalibration process, often using specialized software and equipment and are essential for maintaining the system's performance over time, particularly in complex setups requiring precise synchronization and alignment.

As used herein, the term “display lens” refers to an optical element designed to control the direction and focus of light emitted from the display surface. In some embodiments, the display lens can be, for example, a microlens or lenticular lens array. The primary function of a display lens is to spatially and angularly distribute light rays to create a three-dimensional visual experience by reconstructing the light field.

As used herein, the term “hogel” is an alternative term for the term “holographic pixel”, which is a cluster of traditional pixels with directional control. An array of hogels can generate a light field. As a pixel describes the spatial resolution of a two-dimensional display, a holographic pixel or hogel describes the spatial resolution of a three-dimensional display.

As used herein, the term “display plane” refers to a physical or virtual plane where hogels are rendered to construct a three-dimensional image. Each hogel serves as a localized source of light rays distributed across various angles, collectively enabling the reproduction of a light field that provides depth, parallax, and realistic 3D visuals to viewers. The display plane, which is typically composed of a plurality of hogels arranged in a grid, ensures a uniform angular distribution of light to maintain image coherence and immersion. Depending on the implementation, the display plane, which can also be referred to as a display screen, can be comprised of a tangible material, such as a transparent or emissive surface, or can be a virtual layer in computational systems. Through precise control of the hogels'properties, such as, for example, intensity, color, and angular resolution, the display plane enables the creation of high-fidelity light fields.

As used herein, the term “hogel pitch” refers to the distance from the center of one hogel to the center of an adjacent hogel.

As used herein, the term “light field” at a fundamental level refers to a function describing the amount of light flowing in every direction through points in space, free of occlusions. A light field can, therefore, represent radiance as a function of position and direction of light in free space. A light field can be synthetically generated through various rendering processes or may be captured from, for example, a virtual or real light field camera, or from an array of virtual or real light field cameras.

As used herein, the term “light field display” refers to a device or system which reconstructs a light field from a finite number of light field radiance samples input to the device or system. Light field radiance samples comprise the color components red, green and blue (RGB). For reconstruction in a light field display, a light field display method can also be understood as a mapping from a four-dimensional space to a single RGB color. The four dimensions include the vertical and horizontal dimensions of the display and two dimensions describing the directional components of the light field. A light field can be defined as the function: LF:
(x, y, u, v)→(r, g, b). For a fixed point (x_{f}, y_{f}) , in the light field, LF: (x, y, u, v) represents a two-dimensional (2D) image referred to as an “elemental image”. The elemental image is a directional image of the light field from a fixed (x_{f}, y_{f}) position. When a plurality of elemental images are connected side by side, the resulting image is referred to as an “integral image”. The integral image can be understood as the set of elemental images that create the entire light field required for the light field display.

As used herein, the term “mechanical gap” refers to physical gap, or spacing, between tiled real light field projector devices. The mechanical gap between projectors introduces several challenges that degrade the quality and continuity of the light field image. Specifically, mechanical gaps resulting from the physical spacing or housing constraints of the projectors create regions with insufficient light coverage, which can be perceived as dark bands or blank areas that disrupt the seamless appearance of a light field display. Additionally, the gaps can cause interruptions in the angular distribution of light rays, leading to angular discontinuities that can manifest as abrupt changes in intensity or viewing perspectives. These inconsistencies can compromise depth perception and parallax, and are particularly noticeable when viewers move across the display. The absence of continuous light projection in gap regions can also result in mismatched depth cues or missing portions of the 3D content. This can be especially problematic in applications requiring precise depth rendering, such as holography or immersive visualization. Small misalignments between adjacent projectors can also exacerbate the issues introduced by the mechanical gaps, causing overlapping or misaligned light rays that distort the image further. Color and brightness discrepancies near the seams between hogels can also be due to variations in projector calibration and variations in the mechanical gap between projectors, amplifying the visual impact of these gaps, creating uneven transitions that break the cohesion of the light field.

As used herein, the term “microlens” refers to a small lens, typically with a diameter in the micrometer-millimeter range, designed to focus or manipulate light at a small scale. Microlenses are often arranged in arrays, known as microlens arrays (MLAs), and can be used in various optical systems to enhance light collection, improve focus, or distribute light more efficiently. Each microlens in an array functions as an independent optical element, focusing or directing light onto a specific target, such as a sensor pixel or another optical layer. In light field displays, microlenses are used for capturing or projecting light rays from multiple angles, enabling the generation of 3D images and providing depth and parallax effects. In imaging systems, microlenses improve image brightness and resolution by efficiently channeling light onto sensors. The small size and precise fabrication of microlenses and microlens arrays allow them to be integrated into compact optical devices such as cameras, augmented reality (AR) viewers, virtual reality (VR) viewers, and advanced imaging systems.

As used herein, the term “pixel” refers to a spatially discrete light emission mechanism used to create a display.

As used herein, the term “pixel pitch” refers to the distance from the center of one pixel to the center of a next or adjacent pixel.

As used herein, the term “simulation” refers to a computer model of an object or physical phenomenon. In an example in optics, simulation can be used for the purpose of study or to develop and refine fabrication specifications for optical devices and systems. Various simulation methods can be used, including but not limited to the following: Finite difference time domain (FDTD), ray tracing, Finite Element Analysis (FEA), and Finite Element Method (FEM).

As used herein, the term “subpixel” refers to the smallest individually controllable element of light emission or modulation that contributes to the overall image formation. Each subpixel is typically associated with a specific color channel (e.g., red, green, or blue in an RGB system) and is a component of a pixel.

As used herein, the term “wavelength” refers to a measure of distance between two identical peaks (high points) or troughs (low points) in a wave, which is a repeating pattern of traveling energy such as light or sound.

Herein is described a light field display system and light field projector device that generates a light field with hogels with a shifted hogel origin at the display plane. The hogel origin referred to herein is the apparent hogel center or geometric origin of each hogel. In the presently described device and system, the hogel origin is shifted at the display plane by the reprojection optical component, which reduces the gap between hogels at the display plane. Reducing the gap between hogels at the display plane reduces the mechanical gap image region and improves the viewing quality of the observed light field image. The present disclosure provides a light field projector device and light field display system for creating a light field display to minimize pixel size, and optimize assembly, alignment, and display viewing parameters. The presently described light field projector device and system can be used in a light field display system to provide a light field suitable for 3D display. The present light field projector device and system can also be used for multiple-view, autostereoscopic, and high-angular resolution, light field display. The light field display created by the presently described device and system may also be viewable with both horizontal and vertical parallax.

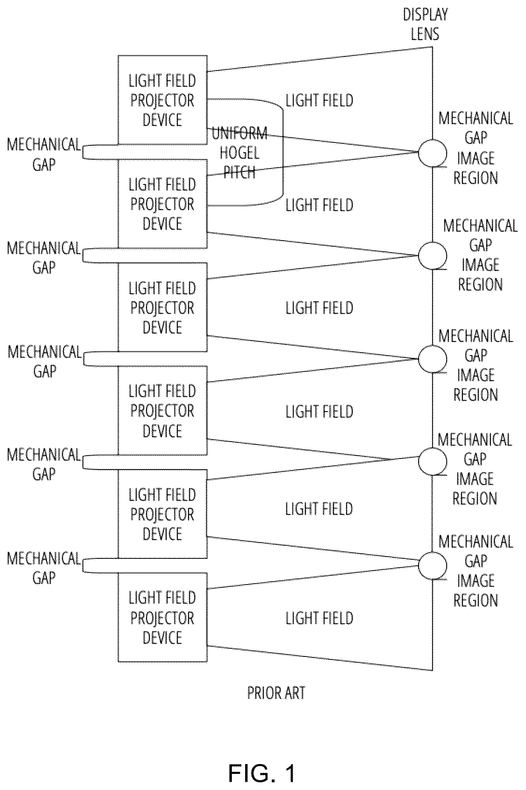

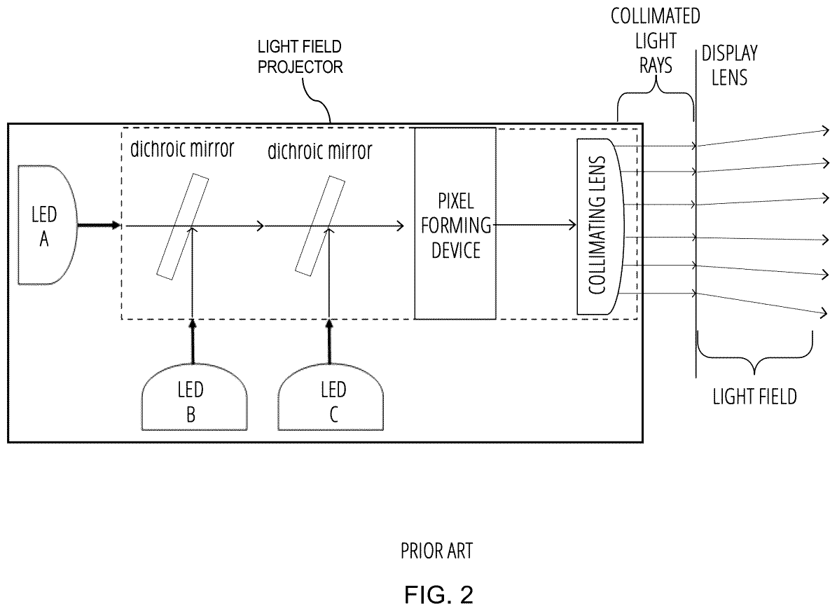

To illustrate the challenge addressed by the present light field display system and device, FIGS. 1 and 2 show a light field projector system and light field projector device, respectively, as known in the art. FIG. 1 is a side view of a light field projection system according to the prior art which illustrates a challenge in light field optical projection. A plurality of light field projector devices are arranged in a projector array to provide a light field. However, there exists a mechanical gap between each of the light field projector devices in the projector array. When the light field is projected from each projector, a mechanical gap image region is produced at the display plane at the intersection of the light field emitted from adjacent light field projectors. This mechanical gap image region is visible as a dark line where there is a break in the light field between projectors. FIG. 2 illustrates a configuration of a light field projector known in the art. In the projector configuration shown, light rays are emitted from a series of three light emitting diodes (LEDs) LED A, LED B, LED C, and directed to a projection optical system having a pixel forming device, followed by a light field optical system having a collimating lens and a display lens for receiving the collimated light rays. It is noted that the scale of the LEDs shown is exaggerated for illustrative purposes. In one embodiment, each light emitting diode emits one of red, green, or blue light. Each light emitting diode can be a single LED or can alternatively be multiple LEDs of the same color, arranged in an array or other configuration. The three individual light rays originating from the three LEDs are directed through a series of two dichroic mirrors in the projection optical system and merged to form a single ray path.

Projector array-based light field displays can pose a challenge for design, at least due to the requirement for inclusion of many densely oriented projectors into a small space with precise alignment. The presently described orientation of optical components within a light field projector in combination with multiple optical systems for collimation and diffusion of light can achieve a reduced pixel size, minimum projector footprint, a fully scalable design to larger displays, reduced tolerance constraint, and decreased chromatic aberration from a multiple optical system light field display design. Known light field display systems emit light as an array of hogels where rays are collimated prior to arriving at the display lens at the display plane. In contrast, in the presently described system and device, each hogel created by the display lens, which can be a microlens array, receives light from the pixel forming device as an elemental image, and is redirected at a redirection angle such that light from hogels projected from farther away from the center of the projector device are projected at a greater angle relative to light from hogels projected from nearer to the center of the projector array. The presently described light field display system and light field display device thereby provides greater control of hogel light projection at the display plane and reduced image gaps in the viewing image.

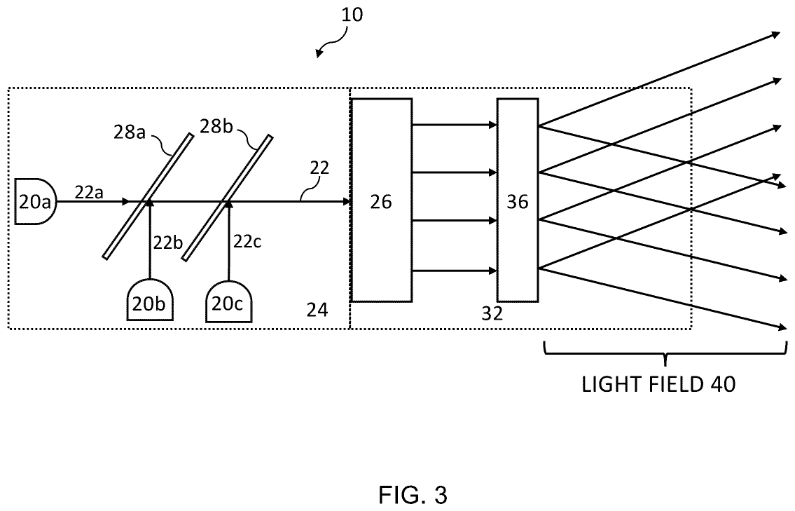

FIG. 3 shows a cross-sectional view of a light field projector device 10. The device 10 comprises a projection optical system 24, a pixel forming device 26, and a light field optical system 32. The projection optical system 24 receives light from light sources and directs the light along a single ray path to the pixel forming device 26. The light field optical system 32 comprises the pixel forming device 26 and a display lens 36. The display lens 36 comprises an array of microlenses arranged to create a light field 40. The projection optical system 24 shown has three light emitting diodes 20a, 20b, 20c that emit light rays 22a, 22b, 22c respectively. Each light emitting diode 20a, 20b, 20c emits light of a different color, such as red, green, or blue. The light rays 22a, 22b, 22c from the three light emitting diodes 20a, 20b, 20c are combined using dichroic mirrors 28a, 28b. Dichroic mirror 28a receives light ray 22a from light emitting diode 20a and light ray 22b from light emitting diode 20b. The dichroic mirror 28a transmits light of one color while reflecting light of another color, thereby combining the two light rays. Dichroic mirror 28b receives the combined light from dichroic mirror 28a and light ray 22c from light emitting diode 20c, further combining the light into a single ray path. The projection optical system 24 directs light along a single ray path 22 to ensure uniform illumination of the pixel forming device 26. The single ray path 22 simplifies the optical design and reduces the complexity of the projection optical system 24. The dichroic mirrors 28a, 28b combine light from multiple light emitting diodes 20a, 20b, 20c without requiring separate optical paths for each color. This configuration reduces the physical size of the light field projector device 10 while maintaining the ability to generate full-color light fields. Although other light sources may be used, light emitting diodes in particular provide a compact light source that enables efficient control of angular light distribution. The compact form factor of light emitting diodes 20a, 20b, 20c reduces the overall footprint of the projection optical system 24 and the light field projector device 10. The controlled angular distribution of light from light emitting diodes also reduces the brightness requirements for illuminating the pixel forming device 26, eliminating the need for internal cooling systems within the housing.

The combined light ray 22 travels through the projection optical system 24 and enters the pixel forming device 26. The pixel forming device 26 converts the incoming light into a pixel array. The pixel forming device 26 modulates the light at individual pixels to create elemental images, and each elemental image corresponds to a hogel in the light field 40. The pixel forming device 26 can be, for example, a liquid crystal display, organic light-emitting diode display, microLED display, digital micromirror device, liquid crystal on silicon device, or quantum dot-based panel. Light exits the pixel forming device 26 and enters the display lens 36. The display lens 36 comprises multiple microlenses arranged in an array, and each microlens receives light from a portion of the pixel array at the pixel forming device 26 and focuses and directs the light to form a hogel. The hogels collectively form the light field 40 that extends outward from the display lens 36. The light field 40 comprises light rays that diverge from the display lens 36 at various angles. The angular distribution of light rays creates the three-dimensional viewing characteristics of the light field 40. A viewer positioned in front of the light field projector device 10 perceives depth and parallax by receiving different light rays from the hogels depending on the viewer's position.

The display lens 36 controls the direction and angular spread of light rays emitted from each hogel, thereby determining the spatial and angular properties of the light field 40. The display lens 36 directs light rays at specified angles to maintain uniform spacing between hogels. This uniform spacing extends across the entire light field 40, including regions where multiple light field projector devices meet. The consistent hogel spacing eliminates discontinuities in the light field at the boundaries between adjacent devices. The light field optical system 32 also separates the formation of hogels from the control of their apparent hogel center positions. The display lens 36 creates hogels from the elemental images generated at the pixel forming device 26. The light field optical system 32 can then manipulate the perceived location of each hogel center by redirecting light rays outward toward the edge of the display lens 36. This separation allows the hogel formation process to be optimized independently from the position control process.

The outward shifting of apparent hogel centers extends the perceived coverage of the light field 40 beyond the physical boundaries of each light field device 10. Light rays are redirected by display lens 36 to create the perception that hogels originate from positions closer to the outer edges of the display lens 36. This extended coverage fills regions between adjacent light field devices in a projector array that would otherwise remain dark due to the mechanical gaps introduced by the housing. The shifted apparent positions create a continuous light field across multiple light field devices without visible seams.

The light field projector device 10 is enclosed within a housing indicated by dashed lines. The housing maintains the alignment and positioning of the projection optical system 24, pixel forming device 26, and light field optical system 32. The housing protects the optical components and provides a structure for mounting the light field projector device 10 in a display system. Multiple light field projector devices 10 can be arranged in an array to form a larger light field display system. The light field projector device 10 allows multiple devices to be positioned adjacent to one another to form a tiled display configuration. The housing of each device 10 introduces mechanical gaps between adjacent units. The optical components within each device 10 can redirect light rays to shift the apparent positions of hogels, thereby covering these mechanical gaps and creating a continuous light field across the boundaries between devices. The redirection of light rays compensates for positional variations between adjacent light field projector devices. This optical compensation reduces the need for precise mechanical alignment during installation such that a plurality of light field projector devices can be mounted in an array with greater tolerance for positioning errors while still being capable of producing a continuous light field.

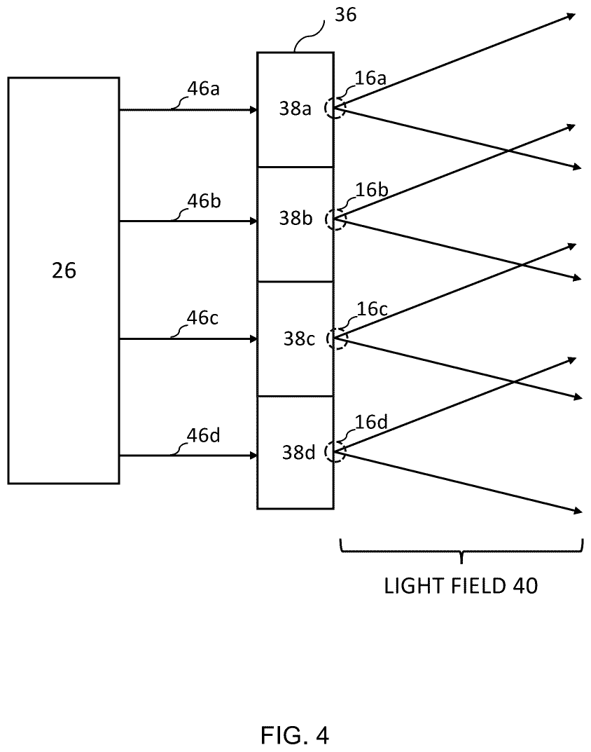

FIG. 4 illustrates features related to those shown in FIG. 3, providing a detailed view of the light field optical system 32. The display lens 36 comprises a microlens array having multiple individual microlenses 38a, 38b, 38c, 38d. Each microlens 38a, 38b, 38c, 38d defines a hogel within the light field 40. The pixel forming device 26 generates elemental images 46a, 46b, 46c, 46d that are directed toward the display lens 36. Each elemental image 46a, 46b, 46c, 46d corresponds to a respective microlens 38a, 38b, 38c, 38d in the microlens array.

Each microlens 38a, 38b, 38c, 38d has an associated actual hogel center 16a, 16b, 16c, 16d, which represents the physical location at which the microlens 38a, 38b, 38c, 38d is positioned within the display lens 36. Light rays exit the pixel forming device 26 as elemental images 46a, 46b, 46c, 46d and travel toward the microlenses 38a, 38b, 38c, 38d. Each microlens 38a, 38b, 38c, 38d receives the light rays from its associated elemental image and directs the light outward to form the light field 40. The display lens 36 processes light from the pixel array 26 to create the plurality of hogels that collectively form the light field 40. Microlenses 38a, 38b, 38c, 38d receive light rays and direct them outward at angles determined by the optical properties of each microlens. The angular distribution of light rays exiting each microlens 38a, 38b, 38c, 38d creates the directional characteristics of the light field 40.

The actual hogel centers 16a, 16b, 16c, 16d are positioned at the physical locations of the microlenses 38a, 38b, 38c, 38d within the display lens 36. The spacing between actual hogel centers 16a, 16b, 16c, 16d determines the hogel pitch across the display lens 36. Each microlens 38a, 38b, 38c, 38d functions as an independent optical element that processes light from a corresponding portion of the pixel array 26. The microlenses 38a, 38b, 38c, 38d are arranged in a grid pattern within the display lens 36, with each microlens 38a, 38b, 38c, 38d occupying a defined region of the array.

The elemental images 46 generated at the pixel forming device 26 contain spatial and angular light information that defines the characteristics of each hogel. The pixel forming device 26 modulates light at individual pixels to create variations in intensity and color across each elemental image 46. These variations encode the directional light distribution that each microlens 38a, 38b, 38c, 38d projects into the light field 40. The elemental images 46 are spatially aligned with the microlenses 38a, 38b, 38c, 38d such that each elemental image 46 is directed to its corresponding microlens 38a, 38b, 38c, 38d. The microlenses 38a, 38b, 38c, 38d in the microlens array can have different properties depending on their position in the array. In some embodiments, microlenses positioned near the edges of the display lens 36 may have different focal lengths, curvatures, or optical characteristics compared to microlenses positioned near the center. These variations in microlens properties allow the light field optical system 32 to compensate for positional effects and maintain uniform light field characteristics across the entire display lens 36. The optical properties of each microlens are selected to optimize the angular distribution of light rays exiting that microlens.

The light field 40 extends outward from the display lens 36 and comprises light rays traveling at various angles. The angular spread of light rays from each microlens in display lens 36 determines the viewing characteristics of the light field 40. A viewer positioned at different locations relative to the display lens 36 receives different combinations of light rays from the hogels, creating the perception of depth and parallax. The microlenses 38a, 38b, 38c, 38d direct light rays such that the angular distribution provides continuous perspective changes as the viewer moves. The display lens 36 thereby creates the light field 40 by directing light from the pixel array 26 through the microlenses 38a, 38b, 38c, 38d. Each microlens 38a, 38b, 38c, 38d contributes to the overall light field 40 by emitting light rays at angles determined by the optical design of the microlens and the content of the corresponding elemental image 46. The light field 40 provides three-dimensional viewing characteristics without requiring specialized eyewear. The hogels formed by the microlenses 38a, 38b, 38c, 38d emit light in multiple directions, enabling viewers at different positions to perceive different views of the displayed content.

The actual hogel centers 16a, 16b, 16c, 16d provide defined reference points within the display lens 36 that establish the spatial positions from which light rays emanate. These reference points can further enable a reprojection optical component to determine the geometric relationships between hogels and calculate the optical transformations needed to shift the apparent positions of the hogels. The defined hogel center positions also allow the system to implement controlled shifts that align hogels from multiple projector devices, facilitating the creation of larger composite light field displays through seamless tiling. The microlenses 38a, 38b, 38c, 38d can also be designed with properties that vary according to their position in the array to work cooperatively with a reprojection optical component. Microlenses positioned toward the outer regions of the display lens 36 may also be configured to produce central rays that are tilted relative to the optical axis. The reprojection optical component can receive these tilted central rays from the outer microlenses and redirect or reproject them to achieve parallel central rays for all hogels, thereby maintaining consistent angular characteristics across the light field 40 regardless of hogel position.

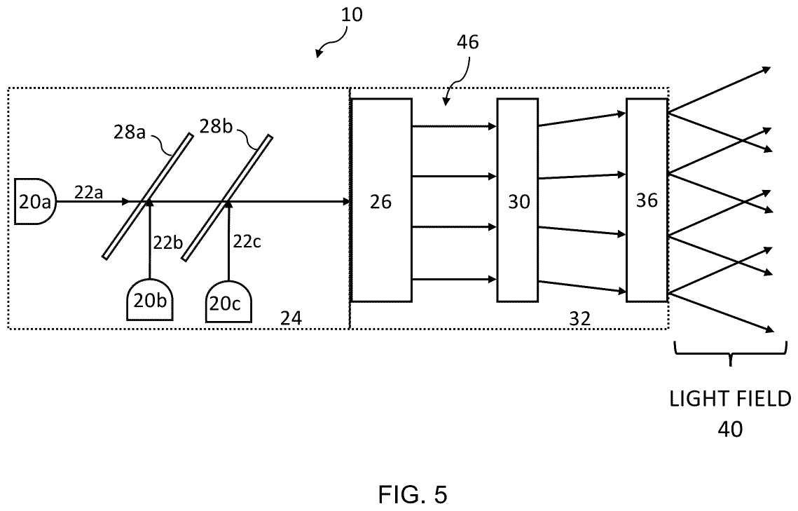

FIG. 5 shows a cross-sectional view of light field projector device 10. The device comprises projection optical system 24, light field optical system 32, and generates light field 40. Projection optical system 24 includes light emitting diodes 20a, 20b, 20c, which emit light rays 22a, 22b, 22c, respectively. Light field optical system 32 comprises pixel forming device 26, reprojection optical component 30, and display lens 36. Light emitting diodes 20a, 20b, 20c generate light rays 22a, 22b, 22c at projection optical system 24. Within projection optical system 24, dichroic mirrors 28a and 28b direct and combine the light rays from the three light emitting diodes. Dichroic mirror 28a receives light from light emitting diode 20a and light emitting diode 20b, transmitting light of one wavelength while reflecting light of another wavelength. Dichroic mirror 28b receives the combined light from dichroic mirror 28a along with light from light emitting diode 20c, further combining the light rays into a single optical path. The combined light exits projection optical system 24 and proceeds to pixel forming device 26.

Pixel forming device 26 receives the combined light from projection optical system 24 and converts the incoming light into a pixel array, creating elemental images 46. Each elemental image corresponds to a hogel in the final light field display. Pixel forming device 26 modulates the intensity and color of individual pixels to generate the desired elemental images. Light exits pixel forming device 26 as divergent rays corresponding to the pixel array. Reprojection optical component 30 receives the divergent light rays from pixel forming device 26 and refocuses and redirects the light rays at specified angles. Different regions of reprojection optical component 30 apply different redirection angles to the light rays passing through them. Light rays corresponding to hogels near the center of the display receive smaller redirection angles, while light rays corresponding to hogels near the edges receive larger redirection angles. The redirected light rays exit reprojection optical component 30 and proceed to display lens 36.

Display lens 36 comprises an array of microlenses arranged in a grid pattern. Each microlens receives redirected light rays from reprojection optical component 30. The redirected light rays arrive at each microlens in the display lens 36 at angles determined by the reprojection optical component 30. Microlenses near the center of display lens 36 receive light rays at angles closer to normal incidence, while microlenses near the edges of the display lens receive light rays at larger angles relative to normal incidence. Each microlens in display lens 36 processes the received light rays to form a hogel, with the angular distribution of light rays from each microlens creating directional light emission. The angled incidence of light rays at microlenses in display lens 36 shifts the apparent center of each hogel. For microlenses positioned near the edges of display lens 36, the larger angles of incidence cause the apparent hogel center to shift outward toward the physical edge of the microlens. This optical shift extends the effective coverage area of light field projector device 10 beyond the physical boundaries of display lens 36. Light rays exit the microlenses in the display lens 36 and propagate outward to form light field 40.

Light field 40 represents the collective output of all hogels generated by microlenses in display lens 36. The shifted apparent hogel centers at the plurality of hogels create a light field distribution that extends to the edges of light field projector device 10. When multiple light field projector devices are arranged adjacent to one another, the outward shift of apparent hogel centers allows the light fields from neighboring devices to overlap in the regions where physical gaps exist between device housings. This overlap fills mechanical gaps that would otherwise appear as dark regions in the combined display.

The optical path through light field projector device 10 transforms light from light emitting diodes 20a, 20b, 20c into a spatially and angularly distributed light field 40. Projection optical system 24 combines light from multiple sources into a single optical path. Pixel forming device 26 creates spatial structure in the light by generating elemental images. Reprojection optical component 30, which can be a metalens, or at least one lens, introduces angular structure by redirecting light rays at position-dependent angles. Display lens 36 converts the redirected light into hogels that emit light in multiple directions. The combination of these optical functions produces light field 40 with apparent hogel positions that compensate for physical spacing between adjacent projector devices in tiled display configurations. The optical shifting of apparent hogel positions enables multiple light field projector devices to be positioned adjacent to one another without creating visible discontinuities in the combined display. The outward shift of apparent hogel centers at the edges of each light field device extends the effective coverage area beyond the physical boundaries of the display lens 36. When devices are arranged side by side, the extended coverage areas overlap in the regions where mechanical gaps exist between device housings, filling spaces that would otherwise appear as dark regions. The redirection of light rays by the reprojection optical component 30 reduces the need for precise mechanical alignment when positioning multiple projector devices relative to one another. In this way, physical spacing tolerances between adjacent devices can be accommodated through optical compensation rather than requiring exact mechanical positioning. This optical approach simplifies the assembly process and reduces installation complexity for displays comprising multiple projector devices. The position-dependent redirection angles applied by the reprojection optical component 30 maintain consistent spacing between hogels throughout the display area. Hogels near the center receive smaller redirection angles while hogels near the edges receive larger redirection angles, creating uniform hogel pitch across the entire display surface. This consistent spacing continues across boundaries where multiple projector devices meet, preventing variations in hogel density that would otherwise create visible discontinuities in the light field 40.

Light emitting diodes provide a compact form factor for the light source components of the light field projector device. The compact size of light emitting diodes 20a, 20b, 20c allows projection optical system 24 to occupy a smaller volume within the device housing. This reduced volume requirement enables the overall footprint of light field projector device 10 to be minimized, facilitating installation in space-constrained environments. Light emitting diodes also offer efficient control over the angular distribution of emitted light. The directional emission characteristics of light emitting diodes 20a, 20b, 20c concentrate light rays 22 within specific angular ranges that align with the acceptance angles of projection optical system 24. This angular control reduces the amount of stray light that would otherwise require absorption or redirection, improving the optical efficiency of the device. The optical efficiency provided by light emitting diodes also reduces the brightness requirements for generating light field 40. Light emitting diodes 20a, 20b, 20c deliver sufficient luminous output to pixel forming device 26 without requiring excessive power consumption. The reduced power consumption eliminates the need for active cooling systems such as fans or heat sinks within light field projector device 10, further contributing to the compact design.

The reprojection optical component 30 refocuses and redirects light rays from elemental images 46 without requiring intermediate collimation optics. This direct processing of divergent light from the pixel forming device 26 reduces the number of optical elements in the light path. The simplified optical architecture decreases the overall length of the device while maintaining the angular precision needed for seamless tiling between adjacent projector devices. The reprojection optical component 30 applies different redirection angles to light rays corresponding to different elemental images. Light rays passing through different regions of the reprojection optical component 30 receive independently controlled angular adjustments based on their position. This position-dependent angular control allows the apparent center of each hogel to be adjusted independently, enabling compensation for varying mechanical gap distances across different regions of a multi-projector display.

The combination of the single ray path design and position-dependent redirection enables multiple projector devices to be arranged in tiled configurations. Each projector device generates hogels with apparent positions that extend beyond the physical boundaries of its display lens 36. The extended coverage areas from adjacent devices overlap to fill mechanical gaps, creating a continuous light field across the entire tiled display without visible boundaries between individual projector devices. The separation of hogel formation from position manipulation through the two-stage optical architecture allows each optical function to be optimized independently. Display lens 36 forms hogels through microlenses without requiring the microlenses themselves to perform position shifting. Reprojection optical component 30 handles the position manipulation by redirecting light rays at controlled angles before they reach display lens 36, enabling precise control over apparent hogel positions without modifying the microlens array geometry. The outward shifting of apparent hogel centers extends the perceived light field coverage beyond the physical boundaries of each projector device. Light rays redirected at larger angles by reprojection optical component 30 cause microlenses 38 near the edges of display lens 36 to emit light with apparent origins positioned outward toward the microlens edges. This optical extension fills regions between adjacent projector devices that would otherwise appear as dark seams due to mechanical spacing between device housings.

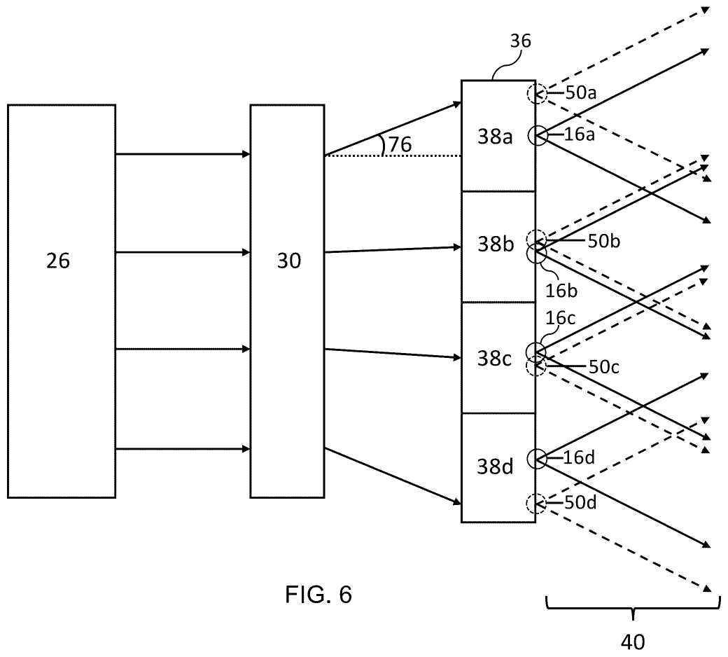

FIG. 6 shows a cross-sectional view of the light field optical system related to features shown in FIG. 5. FIG. 6 provides a detailed view of the optical path through reprojection optical component 30 and display lens 36. Pixel forming device 26 generates elemental images that are transmitted to reprojection optical component 30. Display lens 36 comprises microlens array, which includes individual microlenses 38a, 38b, 38c, 38d. Each microlens defines a hogel in light field 40. The arrangement demonstrates how reprojection optical component 30 redirects light rays to create apparent hogel centers that differ from actual hogel centers, also referred to as hogel center displacement. Pixel forming device 26 emits light rays corresponding to elemental images. These light rays travel along multiple paths toward reprojection optical component 30. The light rays diverge as they propagate from pixel forming device 26. Reprojection optical component 30 receives the divergent light rays and processes them to redirect their paths. The amount of angular redirection applied by reprojection optical component 30 varies depending on the position of the corresponding microlens in display lens 36. Display lens 36 receives the redirected light rays from reprojection optical component 30 and creates light field 40. The hogels defined by display lens 36 emit light rays at various angles, providing directional light distribution for three-dimensional viewing.

Reprojection optical component 30 redirects light rays at redirection angle 76. The magnitude of redirection angle 76 differs for light rays directed to different microlenses. Light rays directed to microlenses positioned near the center of display lens 36 are redirected at smaller redirection angles. Light rays directed to microlenses positioned near the edges of display lens 36 are redirected at larger redirection angles. This position-dependent redirection creates varying apparent hogel positions across display lens 36. Display lens 36 comprises microlenses 38a, 38b, 38c, 38d arranged in an array. Although illustrated as linear, it is understood that the microlens array extends in two orthogonal directions. Each microlens receives redirected light rays from reprojection optical component 30. The positioning of the microlenses in the microlens array determines the redirection angles applied to their corresponding light rays.

Each microlens has an actual hogel center corresponding to its physical center point, where microlens 38a has actual hogel center 16a, microlens 38b has actual hogel center 16b, microlens 38c has actual hogel center 16c, and microlens 38d has actual hogel center 16d. The actual hogel centers 16a, 16b, 16c, 16d represent the physical locations where light rays converge at each microlens. These physical locations remain fixed relative to the mechanical structure of display lens 36. The redirection of light rays by reprojection optical component 30 creates apparent hogel centers that differ from actual hogel centers. In particular, microlens 38a produces apparent hogel center 50a, microlens 38b produces apparent hogel center 50b, microlens 38c produces apparent hogel center 50c, and microlens 38d produces apparent hogel center 50d. The apparent hogel centers 50a, 50b, 50c, 50d represent the perceived locations from which light rays appear to originate when viewed from a position beyond display lens 36. The apparent hogel centers 50a, 50b, 50c, 50d are shifted outward relative to actual hogel centers 16a, 16b, 16c, 16d.

The offset distance between actual hogel center and apparent hogel center varies across display lens 36. For microlens 38a positioned near the edge, apparent hogel center 50a is offset from actual hogel center 16a by a distance that shifts the apparent center outward toward the edge of display lens 36. For microlens 38b positioned between edge and center, apparent hogel center 50b is offset from actual hogel center 16b by a smaller distance than the offset for microlens 38a which is at the edge of display lens 36. For microlens 38c positioned between center and opposite edge, apparent hogel center 50c is offset from actual hogel center 16c by a distance comparable to the offset for microlens 38b. For microlens 38d positioned near the opposite edge, apparent hogel center 50d is offset from actual hogel center 16d by a distance comparable to the offset for microlens 38a.

The offset distance increases as a function of redirection angle 76. Larger redirection angles produce larger offset distances between actual and apparent hogel centers. Microlenses positioned near the edges of display lens 36 receive light rays redirected at larger redirection angles, resulting in larger offset distances for their apparent hogel centers, whereas microlenses positioned near the center of display lens 36 receive light rays redirected at smaller redirection angles, resulting in smaller offset distances for their apparent hogel centers. This relationship between redirection angle and offset distance enables controlled positioning of apparent hogel centers across display lens 36. The outward shift of apparent hogel centers extends the effective coverage area of light field 40 beyond the physical boundaries of display lens 36. Apparent hogel center 50a is shifted outward toward the left edge of display lens 36, extending the perceived light field coverage in that direction. Apparent hogel center 50d is shifted outward toward the right edge of display lens 36, extending the perceived light field coverage in the opposite direction. The extended coverage areas fill regions that would otherwise appear as gaps when multiple light field projector devices are positioned adjacent to one another. The properties of microlenses 38a, 38b, 38c, 38d in the microlens array can vary depending on their position in the array. Microlenses positioned near the edges may have different focal lengths, curvatures, or orientations compared to microlenses positioned near the center. These varying properties work in conjunction with the position-dependent redirection provided by reprojection optical component 30. The combination of varying microlens properties and varying redirection angles enables precise control over the apparent positions of hogels across the entire display lens 36.

The redirected light rays arrive at each microlens at angles determined by redirection angle 76. For microlens 38a, the light rays arrive at a first angle relative to the normal of the microlens surface. For microlens 38b, the light rays arrive at a second angle smaller than the first angle. For microlens 38c, the light rays arrive at a third angle comparable to the second angle. For microlens 38d, the light rays arrive at a fourth angle comparable to the first angle. The varying arrival angles cause the microlenses to emit light with apparent origins shifted from their actual physical centers.

Display lens 36 defines multiple hogels through microlenses 38a, 38b, 38c, 38d, with each hogel having an associated elemental image and an actual hogel center. The actual hogel centers 16a, 16b, 16c, 16d provide fixed reference points corresponding to the physical center locations of their respective microlenses. These reference points enable reprojection optical component 30 to calculate the required redirection angles for creating apparent hogel centers 50a, 50b, 50c, 50d that are shifted from the actual hogel centers by predetermined offset distances. The relationship between actual hogel centers and apparent hogel centers establishes a coordinate framework for implementing position-dependent optical shifts across display lens 36. Reprojection optical component 30 uses the known positions of actual hogel centers to determine the appropriate redirection angle 76 for each microlens location. The calculated redirection angles produce apparent hogel centers 50a, 50b, 50c, 50d with outward shifts that increase toward the edges of display lens 36, creating extended light field coverage that facilitates seamless alignment when multiple devices are positioned adjacent to one another.

The outward shifting of apparent hogel centers from actual hogel centers extends the effective coverage area of the light field projector device to the edge of display lens 36. This extension enables the perceived light field to reach beyond the physical boundaries of the device housing. When multiple projector devices are positioned adjacent to one another, the extended coverage areas from neighboring devices overlap in the regions where mechanical gaps exist between housings, optically filling these gaps without requiring additional hardware components or modifications to the physical structure. The increasing offset distance as a function of redirection angle 76 provides greater optical shift for microlenses positioned near the edges of display lens 36 compared to microlenses positioned near the center. Microlenses at edge positions, such as microlens 38a and microlens 38d, receive light rays redirected at larger redirection angles, producing larger offset distances between their actual hogel centers and apparent hogel centers. This progressive scaling of offset distances ensures that mechanical gaps between adjacent projector devices receive maximum optical compensation at the edges where gaps occur, while central regions maintain minimal shift to preserve optical accuracy where no gaps exist. The varying properties of microlenses depending on their position in microlens array 38 enable coordinated optical design with reprojection optical component 30. Microlenses positioned near the edges of display lens 36 can have different focal lengths or optical axes compared to microlenses positioned near the center, allowing them to produce central rays at tilted angles. Reprojection optical component 30 processes these tilted central rays from outer microlenses and redirects them to achieve parallel central rays for all hogels after the redirection, creating uniform angular distribution across the entire light field 40.

The optical configuration shown in FIG. 6 enables seamless tiling of multiple light field projector devices. When two projector devices are positioned adjacent to one another, the outward shift of apparent hogel centers at the edges of each device causes the light fields to overlap in the region where a mechanical gap exists between device housings. The overlapping light fields fill the mechanical gap, eliminating dark regions that would otherwise be visible at the interface between devices. The uniform spacing of apparent hogel centers across multiple devices creates a continuous light field without visible seams or discontinuities.

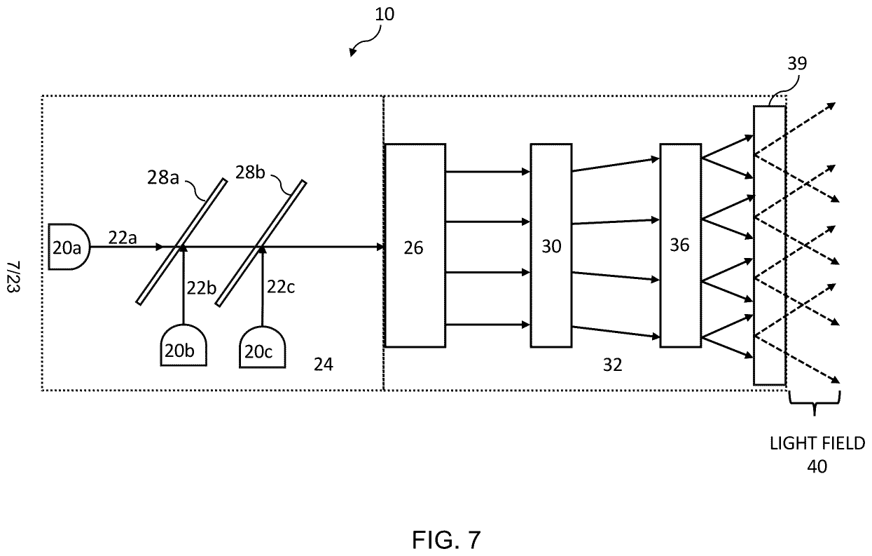

FIG. 7 presents a cross-sectional view of a light field projector device 10. The light field projector device 10 includes a projection optical system 24 and a light field optical system 32. The projection optical system 24 comprises three light emitting diodes 20a, 20b, 20c, each emitting light rays 22a, 22b, 22c respectively. Two dichroic mirrors 28a, 28b are positioned to combine the light rays from the three light emitting diodes into a single ray path. The first dichroic mirror 28a receives light rays 22a and 22b, while the second dichroic mirror 28b receives the combined light from mirror 28a along with light ray 22c, merging all three light rays into a unified beam directed toward the light field optical system 32.

The light field optical system 32 receives the merged light beam from the projection optical system 24. The light field optical system 32 processes the combined light from the projection optical system 24 to create the light field 40. The pixel forming device 26, reprojection optical component 30, display lens 36, and hogel position shifting optical element 39 form a sequence of optical stages that transform the incoming light into a spatially and angularly distributed light field. Each stage contributes to the final light field characteristics.

The pixel forming device 26 is positioned to receive the merged light beam and converts the incoming light beam into a spatially modulated pixel array that creates elemental images. Each elemental image corresponds to a hogel in the resulting light field 40. The pixel forming device 26 modulates the incoming light to produce the desired spatial and angular distribution of light rays for each hogel. The pixel forming device 26 regions of the pixel forming device 26 create different elemental images, with each elemental image containing the light information for a single hogel. The pixel forming device 26 controls the intensity and distribution of light across the pixel array to generate the desired elemental images. The reprojection optical component 30 receives light from each pixel in the pixel forming device 26 and refocuses this light into directed beams. Each beam corresponds to a light ray within an elemental image.

Light from the pixel forming device 26 diverges as it travels toward the reprojection optical component 30. The reprojection optical component 30 receives this divergent light and refocuses it, redirecting each light ray at a specified redirection angle, applying position-dependent redirection, with the amount of redirection varying based on which hogel the light ray belongs to and the position of that hogel within the display area. The reprojection optical component 30 receives divergent light from the pixel forming device 26 and directly refocuses this light into redirected beams without requiring an intermediate collimation stage. The reprojection optical component 30 processes light from each elemental image separately, applying different redirection angles to different light rays within an elemental image based on their position. This direct refocusing and redirection simplifies the optical architecture by reducing the number of optical elements needed between the pixel forming device 26 and the display lens 36. The simplified architecture facilitates seamless tiling of multiple projector devices because fewer optical components reduce alignment complexity and minimize cumulative optical aberrations at device boundaries. The reprojection optical component 30 applies position-dependent redirection to light rays from each elemental image, enabling independent control of redirection angles for different hogels across the display area. Each elemental image receives a specific redirection treatment based on its position within the pixel array, allowing precise adjustment of apparent hogel positions to match varying mechanical gap distances between adjacent projector devices. This independent angular control accommodates non-uniform gap spacing and positioning variations that occur during assembly of tiled display systems.

The display lens 36 comprises an array of microlenses. Each microlens receives redirected light rays from the reprojection optical component 30. The redirected light rays arrive at the microlenses at angles that vary depending on the position of each microlens within the array. Microlenses positioned near the edges of the display lens 36 receive light rays at larger angles relative to normal incidence compared to microlenses positioned near the center of the display lens 36. Each microlens focuses the received light rays to create a hogel. The microlenses in the display lens 36 receive the redirected light rays from the reprojection optical component 30. Each microlens processes light rays from a single elemental image. The off-normal incidence of the light rays at each microlens creates an initial shift in the hogel center position. Microlenses near the edges of the microlens array in the display lens 36 receive light at more oblique angles than microlenses near the center.

A hogel position shifting optical element 39 is positioned after the display lens 36. In one embodiment, the hogel position shifting optical element 39 is a beam spreader. As used herein, the term “beam spreader” refers to an optical assembly configured to receive the output light field from the display lens 36 and change the cross-sectional area and collective divergence angle of the light field output. In operation, the hogel position shifting optical element 39 receives a plurality of divergent hogel light fields having a first collective cross-sectional area and a first collective divergence angle for each hogel, and the hogel position shifting optical element 39 transmits an output light field having a second collective cross-sectional area larger than the first collective cross-sectional area, and a second collective divergence angle smaller or equal than the first collective divergence angle, while maintaining the relative spatial topology of the plurality of discrete hogel outputs. The hogel position shifting optical element 39 receives light rays emitted from the microlenses in display lens 36 and redirects these rays to shift the apparent positions of the hogels as perceived by a viewer. The dashed lines shown extending from the hogel position shifting optical element 39 represent the apparent light ray paths, while the solid lines represent the actual light ray paths. The hogel position shifting optical element 39 creates apparent hogel centers that are displaced from the actual physical centers of the microlenses in the display lens. The hogel position shifting optical element 39 thereby redirects light rays at varying angles across the display area. Light rays from hogels near the edges of the display lens 36 experience larger redirection angles than light rays from hogels near the center. This variation in redirection causes the apparent hogel centers to shift outward toward the edges of the light field projector device 10. The outward shift of apparent hogel centers extends the effective coverage area of the light field 40 beyond the physical boundaries of the display lens 36.

When multiple light field projector devices 10 are arranged in an array, the outward shift of apparent hogel centers compensates for mechanical gaps between adjacent devices. The shifted apparent hogel positions create overlapping coverage in regions where physical gaps exist between projector housings. This optical compensation maintains uniform hogel pitch across the entire array, eliminating visible dark seams that would otherwise appear at the boundaries between adjacent projector devices. The hogel position shifting optical element 39 provides additional redirection of the light rays after they pass through the display lens 36. This post-display-lens redirection creates apparent hogel positions that differ from the physical positions of the microlenses 38. The hogel position shifting optical element 39 can comprise one or more lenses that refract the light rays to create the desired apparent positions. The combined effect of the reprojection optical component 30 and the hogel position shifting optical element 39 creates a light field 40 with apparent hogel centers positioned to compensate for mechanical gaps in tiled display configurations. The reprojection optical component 30 redirects light before it reaches the display lens 36, while the hogel position shifting optical element 39 redirects light after it passes through the display lens 36. These two stages of redirection work together to shift the apparent hogel centers outward. The hogel position shifting optical element 39 creates apparent hogel positions by redirecting light rays such that they appear to originate from locations different from the physical positions of the microlenses 38. A viewer positioned to receive the light field 40 perceives hogels at the apparent positions rather than at the actual microlens positions. This perceptual shift enables the light field projector device 10 to project hogels that appear to extend beyond the physical boundaries of the display lens 36.

The light emitting diodes 20a, 20b, 20c can emit light of different colors. In examples where the three light emitting diodes emit red, green, and blue light respectively, the dichroic mirrors 28a, 28b combine these colors to create full-color illumination. The first dichroic mirror 28a may allow transmission of green light while reflecting red light, and the second dichroic mirror 28b may allow transmission of the combined red and green light while reflecting blue light. The projection optical system 24 may also include additional optical elements beyond the dichroic mirrors 28a, 28b. These additional elements can include, for example, lenses for shaping and directing the light beams, apertures for controlling beam size, and filters for adjusting spectral characteristics. The configuration shown focuses on the dichroic mirrors 28a, 28b as the components for combining light from multiple sources.

When multiple light field projector devices 10 are positioned adjacent to one another in a tiled configuration, physical gaps exist between the housings of neighboring devices. The hogel position shifting optical element 39 redirects light rays to shift the apparent hogel centers outward toward the edges of each device, extending the effective coverage area beyond the physical boundaries of the display lens 36. The outward shift of apparent hogel positions from adjacent devices creates overlapping coverage in the regions where physical gaps exist, optically bridging these gaps so that no dark seams appear in the combined light field. The hogel position shifting optical element 39 in particular can compensate for mechanical gaps through optical redirection rather than requiring precise physical positioning of adjacent devices. In some instances, physical alignment tolerances for the projector devices may be slightly alleviated as a result of the optical compensation provided by the hogel position shifting optical element 39 accounts for positioning variations. Assembly and installation of large-scale tiled displays may be therefore simplified because the light field optical system accommodates mechanical imperfections that would otherwise create visible discontinuities. The reprojection optical component 30 and the hogel position shifting optical element 39 can also work cohesively to maintain consistent angular spacing between hogels across the entire tiled display. Light rays from hogels near the edges of each device experience larger redirection angles than light rays from hogels near the center, creating an outward shift that preserves uniform hogel pitch. The consistent spacing extends across boundaries where multiple projector devices meet, eliminating discontinuities in the light field 40 that would otherwise disrupt the viewing experience.

Light emitting diodes offer efficient control over the angular distribution of emitted light. The directional emission characteristics of light emitting diodes 20a, 20b, 20c concentrate light output within specific angular ranges, reducing the amount of stray light that requires management through additional optical components. This controlled angular distribution allows the projection optical system 24 to direct light efficiently toward the dichroic mirrors 28a, 28b and subsequently to the pixel forming device 26. Light emitting diodes operate with lower brightness requirements compared to alternative light sources while maintaining adequate illumination for the light field 40. The efficient light output of light emitting diodes 20a, 20b, 20c reduces the total power consumption of the projection optical system 24. Lower power consumption reduces heat generation within the light field projector device 10, eliminating the need for internal cooling systems that would increase device complexity and size.

The combination of the single ray path created by the projection optical system 24 and the hogel-specific redirection provided by the reprojection optical component 30 enables efficient scaling to large display systems through tiling of multiple projector devices. The single ray path ensures consistent illumination characteristics across all hogels within a device, while the hogel-specific redirection maintains uniform hogel pitch when multiple devices are arranged in an array. This architecture eliminates visible boundaries between adjacent devices by optically compensating for mechanical gaps, allowing seamless expansion of display area through addition of projector units. The display lens 36 maintains fixed microlens positions and properties while the hogel position shifting optical element 39 independently handles position shifting functions. This separation of hogel formation from position shifting simplifies the optical design by allowing each component to perform a distinct function without interdependencies. The hogel position shifting optical element 39 positioned after the display lens 36 further enables manipulation of apparent hogel positions without requiring changes to the physical design of the microlens array. The hogel position shifting optical element 39 also redirects light rays to create apparent hogel centers that differ from the actual physical centers of the microlenses 38 as perceived by viewers. This redirection creates apparent hogel positions that extend beyond the physical boundaries of the display lens 36 while the microlenses 38 remain at their fixed physical locations. The difference between apparent and actual hogel centers enables optical compensation for mechanical gaps between adjacent projector devices in tiled configurations without requiring physical repositioning of the microlenses. The display lens 36 can also operate independently from the hogel position shifting optical element 39, allowing the microlenses 38 to have uniform or varying properties based on design requirements. The hogel position shifting optical element 39 handles position manipulation regardless of the specific microlens configuration used in the display lens 36. This independence provides flexibility to optimize the display lens 36 for different performance characteristics while maintaining consistent position shifting functionality through the hogel position shifting optical element 39. The hogel position shifting optical element 39 positioned after the display lens 36 also separates hogel formation from position manipulation, enabling independent optimization of each optical function. The display lens 36 creates hogels through the microlenses 38 while the hogel position shifting optical element 39 independently shifts the apparent positions of these hogels. This separation allows the microlens array to be designed for optimal hogel formation characteristics without constraints imposed by position shifting requirements.

The outward shift of apparent hogel centers extends the perceived light field coverage beyond the physical boundaries of each projector device. The hogel position shifting optical element 39 redirects light rays such that apparent hogel centers appear at positions displaced outward from the actual microlens locations. This extended coverage fills regions between adjacent projector devices that would otherwise appear as dark seams, maintaining continuous light field coverage across the entire tiled display array.

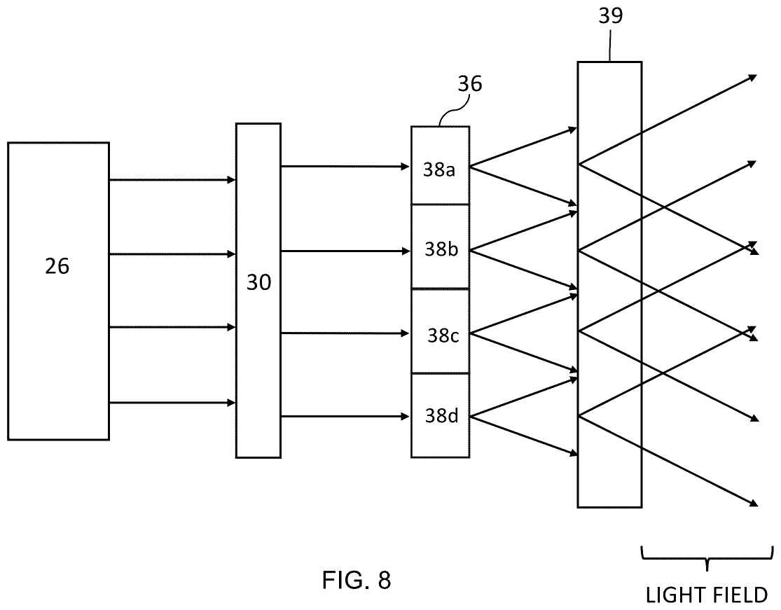

FIG. 8 relates to the features shown in FIG. 7 and presents a closer view of the light field optical system. The light field optical system comprises a pixel forming device 26, a reprojection optical component 30, a display lens 36, and a hogel position shifting optical element 39. The pixel forming device 26 generates elemental images that are directed to the reprojection optical component 30. The reprojection optical component 30 receives these elemental images and redirects them toward the display lens 36 at specified angles. The display lens 36 comprises a microlens array with individual microlenses 38a, 38b, 38c, 38d arranged in sequence. Each microlens 38a, 38b, 38c, 38d receives redirected light from the reprojection optical component 30 and defines a hogel in the resulting light field 40.

The reprojection optical component 30 redirects elemental images according to a redirection angle. The redirection angle varies depending on the position of each microlens within the display lens 36. Microlenses positioned near the center of the display lens 36 receive light at smaller redirection angles relative to normal incidence, while microlenses positioned near the edges receive light at larger redirection angles. The variation in redirection angle across the display lens 36 creates position-dependent redirection of light rays that contributes to shifting the apparent positions of hogels. Each microlens 38a, 38b, 38c, 38d has an actual hogel center which represents the physical geometric center of each microlens where light rays would converge if the microlens received normally incident light. The actual hogel centers are fixed by the physical positions of the microlenses 38a, 38b, 38c, 38d within the display lens 36.

The reprojection optical component 30 redirects light rays such that they arrive at each microlens at angles offset from normal incidence. This angular offset causes the light rays to focus at positions displaced from the actual hogel centers. The displaced focus positions create apparent hogel centers that differ from the actual hogel centers, where each apparent hogel center is offset from its corresponding actual hogel center by an offset distance toward the edge of the display lens 36. The offset distance between actual hogel centers and apparent hogel centers varies across the display lens 36. Microlenses near the edges of the display lens 36 experience larger offset distances than microlenses near the center. Microlens 38a, positioned at the leftmost edge in the figure, has an apparent hogel center 50a that is displaced further from its actual hogel center 16a compared to the displacement between actual and apparent hogel centers for more centrally positioned microlenses. Similarly, microlens 38d, positioned at the rightmost edge, has an apparent hogel center 50d displaced significantly from its actual hogel center 16d toward the right edge of the display lens 36.

The hogel position shifting optical element 39 is positioned after the display lens 36. Light rays passing through the microlenses 38a, 38b, 38c, 38d continue to the hogel position shifting optical element 39. The hogel position shifting optical element 39 receives these light rays and applies additional redirection to further shift the apparent positions of the hogels as perceived by a viewer. The hogel position shifting optical element 39 refracts the light rays to create viewer-perceived hogel positions that differ from both the actual hogel centers and the intermediate apparent hogel centers created by the reprojection optical component 30. The combined effect of the reprojection optical component 30 and the hogel position shifting optical element 39 creates a two-stage shifting of apparent hogel positions. The reprojection optical component 30 provides an initial shift by redirecting light rays before they reach the display lens 36, creating the apparent hogel centers. The hogel position shifting optical element 39 provides a second shift by redirecting light rays after they pass through the display lens 36, creating final apparent hogel positions as perceived by viewers. The two stages of shifting work together to extend the effective coverage area of the light field 40 beyond the physical boundaries of the display lens 36.

The microlenses 38a, 38b, 38c, 38d can have different properties depending on their position in the array. Outer microlenses 38a and 38d may have optical characteristics that differ from inner microlenses 38b and 38c. The varying properties can include differences in focal length, curvature, or orientation. When outer microlenses 38a and 38d produce tilted central rays due to their position-specific properties, the hogel position shifting optical element 39 can be configured to work in conjunction with these varying microlenses to achieve parallel central rays for all hogels after the light passes through the hogel position shifting optical element 39.

The display lens 36 can alternatively comprise microlenses having uniform properties across the microlens array. When the microlenses 38a, 38b, 38c, 38d have identical optical characteristics regardless of position, the reprojection optical component 30 and the hogel position shifting optical element 39 provide all necessary position-dependent optical manipulation. The uniform microlenses simplify manufacturing while the reprojection optical component 30 and hogel position shifting optical element 39 create the position-dependent shifts needed for seamless tiling.

The light field 40 created by the light field optical system 32 exhibits apparent hogel positions that compensate for mechanical gaps between adjacent projector devices in tiled configurations. The outward shift of apparent hogel centers toward the edges of the display lens 36 extends the light field coverage into regions where physical gaps exist between projector housings. When multiple light field projector devices are arranged adjacent to one another, the extended light field coverage from each device overlaps in the gap regions, optically bridging the mechanical gaps and maintaining continuous light field coverage across the entire tiled array.

The pixel forming device 26 generates elemental images as groups of pixels arranged in a spatial pattern. Each elemental image contains the light information for a single hogel, including the intensity and color distribution across multiple viewing angles. The pixel forming device 26 modulates light at individual pixel locations to create the desired angular distribution of light rays within each elemental image. Different elemental images correspond to different hogels and receive different processing by the reprojection optical component 30 based on their positions within the pixel array.

The reprojection optical component 30 receives divergent light from each elemental image generated by the pixel forming device 26. Light rays from each pixel within an elemental image diverge as they travel from the pixel forming device 26 to the reprojection optical component 30. The reprojection optical component 30 refocuses these divergent rays and redirects them at the redirection angle appropriate for the position of the corresponding hogel within the display lens 36. The refocusing and redirection transform the divergent light from the pixel forming device 26 into directed beams that arrive at the display lens 36 at specified angles. The redirection angle determines the angle at which light rays arrive at each microlens in the display lens 36. Larger redirection angles result in light rays arriving at more oblique angles relative to the normal of the display lens 36. Smaller redirection angles result in light rays arriving at angles closer to normal incidence. The variation in redirection angle across the display lens 36 creates the position-dependent offset between actual hogel centers and apparent hogel centers.

The hogel position shifting optical element 39 can comprise one or more lenses positioned after the display lens 36. When implemented as multiple lenses, the hogel position shifting optical element 39 can provide enhanced control over the final apparent hogel positions by combining the optical effects of multiple refractive surfaces. The multiple lenses can be arranged at specified distances from one another and from the display lens 36 to achieve desired magnification characteristics and position shifting behavior. The offset distance between actual hogel centers and apparent hogel centers increases progressively from the center of the display lens 36 toward the edges. Microlens 38a at the left edge has the largest leftward offset, while microlens 38d at the right edge has the largest rightward offset. Microlenses 38b and 38c positioned between the center and edges have intermediate offset distances. This progressive increase in offset distance creates a controlled expansion of the apparent hogel distribution that extends the light field coverage outward from the physical boundaries of the display lens 36.

The hogel position shifting optical element 39 functions as a magnifying optical system that alters the perceived spatial distribution of hogels without changing the physical positions of the microlenses 38a, 38b, 38c, 38d. A viewer positioned to observe the light field 40 perceives hogels at locations determined by the optical redirection provided by the hogel position shifting optical element 39 rather than at the physical locations of the microlenses. This perceptual displacement enables the light field projector device to project apparent hogel positions that extend beyond the physical boundaries of the display lens 36, filling mechanical gaps between adjacent projector devices in tiled configurations. The light field optical system 32 also maintains uniform hogel pitch across the display area despite the varying offset distances between actual and apparent hogel centers. The spacing between adjacent apparent hogel centers 50a, 50b, 50c, 50d remains consistent even as the individual offset distances vary. The reprojection optical component 30 and hogel position shifting optical element 39 coordinate their respective redirection functions to preserve uniform spacing between apparent hogel positions while shifting these positions outward toward the edges of the device.

When multiple light field projector devices are arranged in a tiled array, the apparent hogel centers near the edges of each device extend into the physical gap regions between adjacent device housings. The apparent hogel center 50a from one device and the apparent hogel center from an adjacent device positioned to the left create overlapping light field coverage in the gap region between the two devices. Similarly, the apparent hogel center 50d and the apparent hogel center from an adjacent device positioned to the right create overlapping coverage in the gap region between those devices. The overlapping coverage eliminates dark seams that would otherwise appear at the boundaries between adjacent projector devices.

The reprojection optical component 30 can be implemented as a metalens or as one or more conventional lenses. When implemented as a metalens, the reprojection optical component 30 uses nanostructured surfaces to manipulate light at subwavelength scales, providing compact optical redirection. When implemented as conventional lenses, the reprojection optical component 30 uses curved refractive surfaces to redirect light rays. Both implementations provide the refocusing and redirection functions needed to create the apparent hogel centers offset from the actual hogel centers.

The light field 40 generated by the light field optical system provides three-dimensional viewing characteristics through the spatial and angular distribution of light rays emitted from each hogel. Each hogel emits light rays in multiple directions, with the angular distribution determined by the elemental image generated at the pixel forming device 26 and the optical processing provided by the reprojection optical component 30, display lens 36, and hogel position shifting optical element 39. A viewer observing the light field 40 from different positions perceives different views of the displayed content due to the directional variation in light rays emitted from each hogel. The position-dependent variation in redirection angle 76 and offset distance enables the light field optical system 32 to compensate for mechanical gaps through optical means rather than requiring sub-millimeter precision in physical alignment of adjacent projector devices. The optical compensation provided by the reprojection optical component 30 and hogel position shifting optical element 39 accommodates mechanical tolerances in the positioning of projector devices within a tiled array. Physical gaps between projector housings are optically bridged rather than eliminated through precise mechanical positioning, simplifying assembly and installation of large-scale tiled displays.

The varying properties of microlenses depending on their position in the array enable coordinated optical design with the reprojection optical component 30 and hogel position shifting optical element 39. Outer microlenses 38a and 38d can be configured with specific focal lengths, curvatures, or orientations that produce tilted central rays corresponding to their edge positions in the display lens 36. The hogel position shifting optical element 39 receives these position-specific tilted central rays and applies compensating redirection to transform them into parallel central rays, ensuring that all hogels emit light with consistent angular characteristics regardless of their position within the display lens 36.

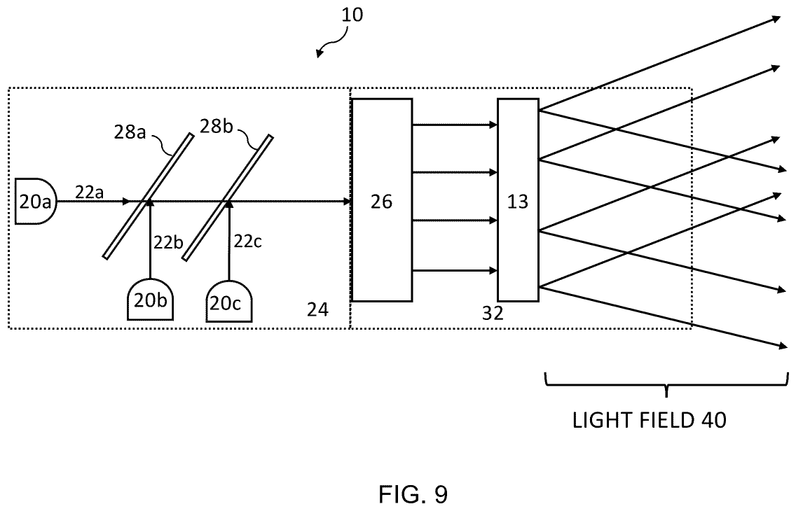

FIG. 9 shows a cross-sectional view of light field projector device 10. The device comprises projection optical system 24 and light field optical system 32. Projection optical system 24 includes light emitting diodes 20a, 20b, 20c, which generates light rays 22a, 22b, 22c, respectively. Light field optical system 32 includes pixel forming device 26 and hogel defining element 13. Light rays 22a, 22b, 22c from light emitting diodes 20a, 20b, 20c travel through dichroic mirrors 28a, 28b in projection optical system 24 and are directed to pixel forming device 26. Light emitting diodes 20a, 20b, 20c may emit red, green, or blue light. Multiple light emitting diodes can be combined to produce full-color output.

Pixel forming device 26 receives light from projection optical system 24 and converts the light into a pixel array. The pixel array creates elemental images. Each elemental image corresponds to a hogel. Pixel forming device 26 selectively modulates the incoming light to create the pixel array. The pixel array comprises rows and columns of pixels, with each pixel capable of independent control. Groups of pixels form elemental images that correspond to individual hogels. The elemental images contain spatial and angular information for reconstructing light field 40. Pixel forming device 26 outputs modulated light that proceeds to hogel defining element 13. Pixel forming device 26 may comprise a Liquid Crystal Display (LCD), Organic Light-Emitting Diode (OLED), microLED, Digital Micromirror Device (DMD), Liquid Crystal on Silicon (LCoS), or quantum dot-based panel. The pixel forming device modulates light intensity and color at individual pixels based on electronic signals.

The hogel defining element 13 is an optical component or system configured to receive elemental images from a pixel forming device and convert them into hogels that collectively form a light field. The hogel defining element processes light rays from each elemental image to create discrete spatial regions or hogels that emit or direct light in multiple angular directions, thereby providing the directional light distribution necessary for three-dimensional viewing with depth and parallax. The hogel defining element may comprise various optical structures including, but not limited to, a microlens array, a lenticular lens, a metalens, one or more conventional lenses, or combinations thereof. When implemented as a metalens, the hogel defining element uses nanostructured surfaces to manipulate light at subwavelength scales through spatially varying arrangements of nanoscale structures or meta-atoms. These meta-atoms are precisely engineered to control the phase, amplitude, polarization, or wavelength of light, enabling the metalens to perform complex optical functions in a compact form factor. By varying the shape, size, orientation, or spacing of meta-atoms across different regions of the metalens surface, the hogel defining element 13 can exhibit different optical properties in different areas, allowing position-dependent manipulation of light rays for hogel formation and positioning. Each portion or element within the hogel defining element corresponds to a specific elemental image and processes the light from that elemental image to form an individual hogel.

In some embodiments, the hogel defining element 13 may also manipulate the apparent positions of hogels by redirecting light rays at specified angles. This redirection can shift the apparent hogel center outward from the actual hogel center of the hogel, extending the effective coverage area of the light field beyond the physical boundaries of the device. Such shifting enables seamless tiling of multiple light field projector devices by optically compensating for mechanical gaps between adjacent device housings. The hogel defining element 13 may also have uniform optical properties across its entire area, or may have spatially varying properties where different regions exhibit different optical characteristics, such as focal length, curvature, or orientation, depending on their position within the element. This spatial variation enables position-dependent control of light ray direction and apparent hogel positioning.

Hogel defining element 13 receives light from pixel forming device 26. Hogel defining element 13 creates hogels from the elemental images generated by pixel forming device 26. Each hogel has an associated elemental image. Hogel defining element 13 directs light rays at specified angles to form the hogels. The hogels collectively produce light field 40, which comprises multiple light rays emitted at various angles, enabling three-dimensional viewing.

Hogel defining element 13 receives the modulated light from pixel forming device 26 and processes it to create hogels. The hogel defining element may comprise a microlens array, lenticular lens, or other optical structure. Each portion of hogel defining element 13 processes light from a corresponding elemental image to form a hogel. The hogels emit light rays at multiple angles, providing directional light information for three-dimensional viewing.

Light field 40 extends outward from hogel defining element 13. Light field 40 comprises light rays traveling at various angles from each hogel. A viewer positioned in front of light field projector device 10 perceives depth and parallax from light field 40. The angular distribution of light rays from the hogels enables different views to be seen from different viewing positions. Light field 40 provides full-parallax viewing with both horizontal and vertical perspective changes. The configuration shown allows light field projector device 10 to generate light field 40 from light emitting diode 20 through the sequential processing by projection optical system 24, pixel forming device 26, and hogel defining element 13. The device provides a compact architecture for light field generation. Multiple light field projector devices 10 can be arranged in an array to form larger light field displays. The modular design enables scalable display systems.

Light field projector device 10 is enclosed within a housing, which maintains the spatial relationships between projection optical system 24, pixel forming device 26, and hogel defining element 13. The housing also provides mechanical support and alignment for the optical components. Flexible printed circuits connect pixel forming device 26 and light emitting diodes to drive electronics that control their operation.

Multiple light field projector devices 10 can be positioned adjacent to one another to form a tiled display configuration. The hogel defining element 13 in each device redirects light rays at specified angles to optically shift the apparent positions of hogels. This optical shifting allows the hogels from adjacent devices to appear continuous across the physical gaps between housings eliminating visible seams in the combined light field.

The optical redirection provided by hogel defining element 13 compensates for minor positional variations between adjacent light field projector devices 10. Physical alignment tolerances for the devices can be relaxed because the optical system adjusts the hogel positions. This simplifies the installation process for multi-device arrays and reduces the mechanical precision needed during assembly. Hogel defining element 13 directs light rays from each elemental image at predetermined angles to establish consistent hogel spacing. The angular redirection maintains uniform pitch between hogels throughout light field 40, including regions where multiple devices meet. This produces a continuous light field without spatial discontinuities at device boundaries.

Light emitting diodes provide a compact light source that reduces the overall size of light field projector device 10. The angular distribution of light from light emitting diodes can be controlled efficiently through projection optical system 24, reducing the brightness requirements compared to other light sources. The reduced brightness requirements and compact form factor enable light field projector device 10 to operate without internal cooling systems, further decreasing the device footprint and simplifying the housing design.

The integration of hogel defining element 13, projection optical system 24, and pixel forming device 26 within a housing provides a self-contained unit for light field generation such that all components required for converting light from light emitting diode 20 into light field 40 are positioned within a single enclosure. This arrangement reduces the physical footprint compared to systems where hogel formation and light projection are implemented in separate modules.

The configuration directs light rays 22 through a sequential path from light emitting diode 20 to pixel forming device 26 before hogel creation. This arrangement reduces the number of optical interfaces and minimizes light losses that occur at each optical surface. The sequential processing through projection optical system 24, pixel forming device 26, and hogel defining element 13 maintains precise control over light distribution throughout the optical path. The self-contained architecture of light field projector device 10 enables multiple devices to be arranged in arrays for larger displays. Each device independently generates its own hogels with associated elemental images from light emitting diode 20 through hogel defining element 13. The modular nature allows display systems to be scaled by adding additional light field projector devices 10 in tiled configurations.

The hogel defining element 13 performs two distinct optical functions within light field projector device 10. Pixel forming device 26 first generates elemental images by converting light rays into a pixel array. Hogel defining element 13 then processes these elemental images to create hogels while simultaneously controlling the apparent positions of the hogel centers through angular redirection of light rays. The angular redirection provided by hogel defining element 13 shifts the apparent hogel centers outward toward the edges of the element. This outward shifting extends the perceived coverage of light field 40 beyond the physical boundaries of housing 16. When multiple light field projector devices 10 are positioned adjacent to one another, the extended coverage from each device fills the physical gaps between housings, creating a continuous light field without dark regions at device boundaries.

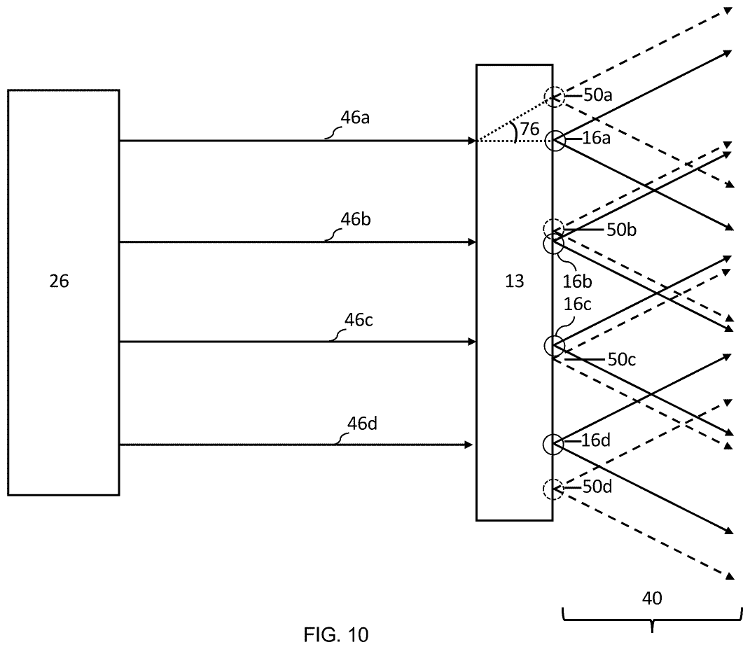

FIG. 10 illustrates a detailed cross-sectional view of the light field optical system introduced in FIG. 9, showing how hogel defining element 13 creates hogels with shifted apparent centers. Light rays as elemental images 46a, 46b, 46c, 46d are directed from pixel forming device 26 to hogel defining element 13. Each elemental image comprises multiple light rays that travel toward hogel defining element 13 and are spatially distributed across the width of pixel forming device 26. Light rays from elemental image 46a travel to a first portion of hogel defining element 13, and light rays from elemental images 46b, 46c, 46d travel to corresponding portions of hogel defining element 13. The spatial arrangement of elemental images on pixel forming device 26 determines the positions where light rays reach hogel defining element 13.

Hogel defining element 13 processes the incoming light rays from each elemental image to create multiple individual hogels. Each hogel has an actual hogel center and an apparent hogel center that differs from the actual hogel center position. The hogel defining element 13 redirects the light rays at specified angles as they pass through. Solid arrows extending upward from hogel defining element 13 represent actual light ray paths. Dashed arrows extending upward from hogel defining element 13 represent apparent light ray paths as perceived by a viewer. The difference between solid and dashed arrows shows the optical redirection provided by hogel defining element 13, where solid arrows represent the original light path direction and dashed arrows represent the redirected light paths.

Actual hogel centers 16a, 16b, 16c, 16d mark the physical positions where hogels are formed at hogel defining element 13. These actual hogel centers 16a, 16b, 16c, 16d represent the physical locations where light rays from pixel forming device 26 are processed by hogel defining element 13. Apparent hogel centers 50a, 50b, 50c, 50d mark the positions where hogels appear to originate as perceived by a viewer observing the light field 40. As shown, apparent hogel center 50a is displaced outward from actual hogel center 16a, apparent hogel center 50b is displaced outward from actual hogel center 16b, apparent hogel center 50c is displaced outward from actual hogel center 16c, and apparent hogel center 50d is displaced outward from actual hogel center 16d. The displacement between each actual hogel center and its corresponding apparent hogel center defines an offset distance. The offset distance between actual hogel center 16a and apparent hogel center 50a represents the spatial shift toward the left edge of hogel defining element 13, and the offset distance between actual hogel center 16d and apparent hogel center 50d represents the spatial shift toward the right edge of hogel defining element 13. Offset distances for hogels positioned near the edges of hogel defining element 13 are larger than offset distances for hogels positioned near the center. This variation in offset distance creates controlled magnification of the light field toward the edges of the device.

Hogel defining element 13 redirects light rays at angles that increase progressively from the center toward the edges. Light rays from actual hogel center 16a are redirected at a first angle to create apparent hogel center 50a. Light rays from actual hogel center 16b are redirected at a second angle to create apparent hogel center 50b. The second angle is smaller than the first angle because actual hogel center 16b is closer to the center of hogel defining element 13 than actual hogel center 16a. Light rays from actual hogel center 16c are redirected at a third angle to create apparent hogel center 50c. Light rays from actual hogel center 16d are redirected at a fourth angle to create apparent hogel center 50d. The fourth angle is larger than the second and third angles because actual hogel center 16d is positioned near the right edge of hogel defining element 13. The progressive increase in redirection angle 76 from center to edge produces corresponding increases in offset distances of the apparent hogel center 50a, 50b, 50c, 50d relative to the actual hogel center 16a, 16b, 16c, 16d. In particular, the offset distance increases as the actual hogel center position moves farther from the center of hogel defining element 13 toward either edge. This relationship between position and offset distance enables uniform apparent hogel spacing across the width of the device. It is noted that the apparent spacing between adjacent apparent hogel centers 50a, 50b, 50c, 50d remains consistent despite the varying offset distances applied to each hogel.

Light field 40 extends away from hogel defining element 13 and comprises light rays emitted from the apparent hogel centers 50a, 50b, 50c, 50d which travel at various angles from each apparent hogel center. Solid arrows show the original paths of light rays through space whereas dashed arrows show the shifted hogel light rays as extrapolated backward from their trajectories. A viewer receiving the light field 40 from hogel defining element 13 perceives the light rays as originating from apparent hogel centers 50a, 50b, 50c, 50d rather than from actual hogel centers 16a, 16b, 16c, 16d. The optical redirection provided by hogel defining element 13 shifts the perceived origin of each hogel outward toward the edges of the element. This outward shifting extends the effective coverage area of light field 40 beyond the physical boundaries of hogel defining element 13. When multiple light field projector devices are arranged adjacent to one another, the extended coverage from each device fills the mechanical gaps between device housings. The apparent hogel centers from one device align with apparent hogel centers from adjacent devices to create uniform hogel spacing across device boundaries. Redirection angle 76 indicates the angular deviation between actual and apparent light ray paths for a hogel positioned near the edge of hogel defining element 13. Redirection angle 76 is measured between a solid arrow representing the original light ray path and a dashed arrow representing the corresponding shifted light ray path. The magnitude of redirection angle 76 determines the offset distance between the actual hogel center and the apparent hogel center for that hogel. Larger redirection angles produce larger offset distances, shifting apparent hogel centers farther outward toward the edges. The relationship between redirection angle 76 and offset distance enables controlled positioning of apparent hogel centers. Hogel defining element 13 applies different redirection angles to light rays from different hogel positions. Light rays from hogels near the center of the hogel defining element 13 experience smaller redirection angles, producing smaller offset distances whereas light rays from hogels near the edges experience larger redirection angles, producing larger offset distances. This position-dependent angular redirection maintains uniform apparent hogel spacing across the entire width of the device.

The configuration shown enables light field projector device 10 to generate light field 40 with optically shifted hogel positions. Pixel forming device 26 creates elemental images that provide the spatial and angular information for each hogel and hogel defining element 13 processes these elemental images to form hogels while simultaneously redirecting light rays to shift the apparent hogel positions outward. The resulting light field 40 has uniform apparent hogel spacing that extends beyond the physical boundaries of the device, enabling seamless tiling when multiple devices are arranged in arrays. The definition of at least two hogels with associated elemental images and actual hogel centers establishes a structured framework for optical manipulation. Each hogel has a defined actual center position at hogel defining element 13, providing a reference point from which the reprojection optical component can calculate the required angular deviation. This reference framework enables hogel defining element 13 to determine the specific redirection angle needed for each hogel position, allowing precise control over the displacement between actual hogel centers and apparent hogel centers. The structured relationship between elemental images, actual hogel centers, and apparent hogel centers facilitates accurate calculation of offset distances across the width of the device. When multiple light field projector devices are arranged adjacent to one another, the defined hogel center from each projector provides alignment references that enable uniform apparent hogel spacing across device boundaries. The outward shifting of apparent hogel centers from actual hogel centers extends the effective coverage area of the light field beyond the physical boundaries of the hogel defining element 13 in each projector. When multiple projector devices are positioned adjacent to one another in an array, the extended coverage from each device reaches into the physical gaps between projector device housings. The apparent hogel centers from one device align with apparent hogel centers from neighboring devices, creating continuous hogel spacing across the entire array without requiring additional optical components or mechanical modifications to fill the gaps between housings.

The progressive increase in offset distance as a function of redirection angle provides tailored optical compensation across the display surface. Hogels positioned near the edges of hogel defining element 13 experience larger redirection angles, which generate correspondingly larger offset distances that shift apparent hogel centers farther outward. Hogels positioned near the center experience smaller redirection angles, producing minimal offset distances that maintain their apparent positions close to their actual positions. This graduated scaling of offset distances ensures that edge hogels extend sufficiently to bridge mechanical gaps between adjacent devices, while central hogels remain substantially unshifted to preserve the natural light field distribution in regions where gap compensation is unnecessary.

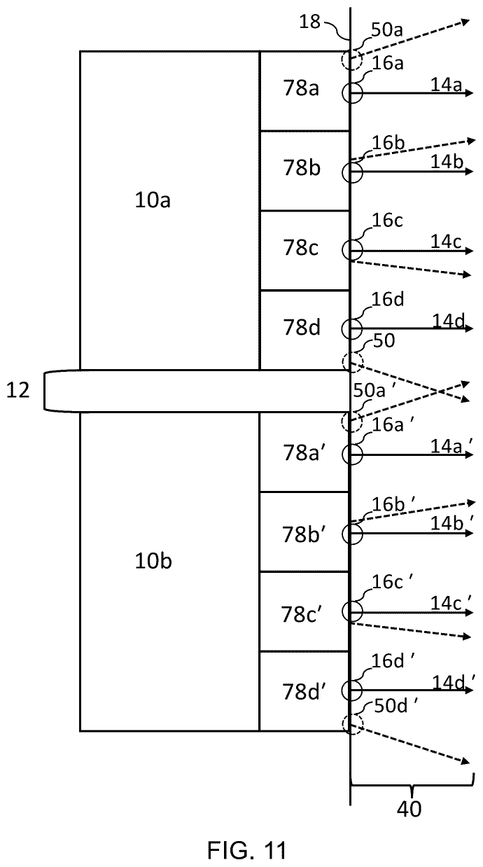

FIG. 11 illustrates an side elevation view of a light field display system comprising an array of light field projector devices 10a, 10b arranged with a mechanical gap 12 between them. Each light field projector device 10a, 10b generates multiple hogels 78a, 78b, 78c, 78d and 78a′, 78b′, 78c′, 78d′ respectively. The hogels collectively form a light field 40 that extends across both projector devices. A display plane 18 is positioned directly in front of the array of light field projector devices 10a, 10b, where the light field 40 is presented for viewing. Each hogel 78a, 78b, 78c, 78d, 78a′, 78b′, 78c′, 78d′ has an actual hogel center 16a, 16b, 16c, 16d, 16a′, 16b′, 16c′, 16d′, representing the physical location at which the hogel-defining optical element is positioned. The actual hogel centers 16a-16d′ correspond to the physical positions of the microlenses or other hogel-defining elements within the display lens of each projector device. A single hogel center ray 14a, 14b, 14c, 14d, 14a', 14b′, 14c′, 14d′ is shown per hogel to represent the central light ray emitted from each hogel. While the hogel center ray 14a-14d′ is depicted as a straight line for simplicity in optical diagrams, in actuality it represents a conical emission of light. Light rays spread outward from the hogel in multiple directions, with the representative ray act as a central line through this cone to approximate the behavior of light for analysis purposes.

The hogel center ray 14a-14d′ for each hogel 78a-78d′ is shifted from the actual hogel center. Light rays comprising elemental images are redirected at specified redirection angles such that the angled light rays are received off-normal by each hogel-defining element. This redirection defines an apparent hogel center 50a, 50d, 50a′, 50d′ that differs from the actual hogel center 16a, 16d, 16a′, 16d′. The apparent hogel centers 50a, 50d, 50a′, 50d′ represent the perceived locations of the hogels as viewed by an observer, which are shifted outward relative to the actual physical positions of the hogel-defining elements. The shifting of apparent hogel centers 50a, 50d, 50a′, 50d′ is more pronounced for hogels near the edges of the light field projector devices 10a, 10b. For example, apparent hogel center 50a is shifted outward from actual hogel center 16a, and apparent hogel center 50d is shifted outward from actual hogel center 16d. This outward shifting creates a dense conical emission of light at the perimeter of each light field projector device 10a, 10b. The controlled redirection of light rays extends the effective coverage area of each projector device beyond its physical boundaries, allowing the light fields from adjacent projectors to overlap in the region of the mechanical gap 12.

The mechanical gap 12 represents the physical spacing between the housings of adjacent light field projector devices 10a, 10b. Without optical compensation, this mechanical gap 12 would create a dark region in the light field 40 where no light is emitted, resulting in a visible seam between the outputs of the two projector devices. The shifting of apparent hogel centers 50a, 50d, 50a′, 50d′ toward the edges of each projector device compensates for the mechanical gap 12 by extending the light field coverage into the gap region. Light rays from hogels near the edges of projector device 10a and hogels near the edges of projector device 10b converge to fill the mechanical gap 12 optically, eliminating the dark region that would otherwise appear.

The display plane 18 is positioned directly in front of the array of light field projector devices 10a, 10b. The display plane 18 represents the surface where the light field 40 is presented and where viewers perceive the three dimensional imagery. The spatial alignment between the display plane 18 and the hogel plane ensures accurate reconstruction of the light field, where the hogel plane refers to the plane where the hogels 78a-78d′ are situated. The display plane 18 serves as the physical or virtual plane where hogels are rendered to construct a three-dimensional image, and each hogel 78a-78d′ functions as a localized source of light rays distributed across various angles, collectively enabling reproduction of the light field 40. The display plane 18, composed of a grid of hogels, ensures uniform angular distribution of light to maintain image coherence and immersion. Through precise control of hogel properties such as intensity, color, and angular resolution, the display plane 18 facilitates creation of high-fidelity light fields suitable for applications including augmented reality, medical imaging, and holographic visualization. When the display plane 18 is positioned directly in front of the hogel plane, the light emitted or diffracted by the hogels converges to form a visible three-dimensional image at the display plane 18. In the configuration shown, the hogel plane and the display plane 18 are closely aligned such that the light field emitted by the hogels intersects at the display plane 18. This alignment allows the display plane 18 to act as the location where the reconstructed image appears, while the hogels provide the directional light data needed to create depth and parallax. The direct spatial relationship between the display plane 18 and the hogel plane ensures optimal focus and clarity, providing a realistic three-dimensional viewing experience. If the alignment were to deviate, the resulting image might appear blurry, misaligned, or distorted, as the directional light information would not converge correctly at the intended viewing area.

Hogel pitch refers to the distance from the center of one hogel to the center of an adjacent hogel. To achieve uniform hogel pitch across the light field display system, the spacing between tiled light field projectors must be maintained consistent. Without optical compensation, the mechanical gap 12 between adjacent projectors would create a region where the hogel pitch increases, resulting in non-uniform spacing. The mechanical gap 12 introduces disruptions due to the absence of light ray projection caused by the physical spacing between adjacent projectors. These regions lack spatial and angular light information, resulting in dark bands or blank areas that visibly interrupt the display's continuity. The abrupt transition between the light fields generated by neighboring projectors creates angular discontinuities where the intended flow of light rays is disrupted. This leads to misaligned depth cues and inconsistent parallax, causing gaps or distortions in the three-dimensional perception of the image. Slight misalignments or variations in brightness and color calibration between projectors can exacerbate these issues, making the seams at the mechanical gaps more pronounced and visually jarring. These effects collectively degrade the seamless and immersive quality expected from a light field display. A uniform hogel pitch produces higher quality light field images by ensuring consistent and accurate distribution of light rays across the display. When the hogel pitch remains uniform, the spacing between emitted light rays remains consistent, maintaining accurate depth information and smooth parallax across the entire display. A uniform hogel pitch also ensures consistent angular resolution, reducing the risk of angular discontinuities or misaligned depth cues that can distort three-dimensional perception. The optical shifting of apparent hogel centers 50a, 50d, 50a′, 50d′ maintains uniform hogel pitch across the boundaries between projector devices 10a, 10b by extending the effective coverage area of each device into the mechanical gap 12 region.

The controlled magnification of the light emitted from each projector device 10a, 10b allows the light fields to align seamlessly with minimal visible border between devices. Light rays from hogels near the edge of projector device 10a and hogels near the edge of projector device 10b are redirected such that their apparent positions extend into the mechanical gap 12. This optical compensation fills the physical spacing between projector housings, creating continuous light field coverage across the entire display area. The result is a light field 40 with uniform hogel spacing throughout, despite the presence of the mechanical gap 12 between the physical projector bodies.

A viewer of a three-dimensional real world object is subject to infinite views, or a continuously distributed light field. The light field display system comprising projector devices 10a, 10b subsamples the continuously distributed light field into a finite number of views to approximate the light field. The output is a light field image representing a three-dimensional reconstruction based upon a finite number of views with angular resolution meeting or exceeding that of the human eye. The shifting of apparent hogel centers 50a, 50d, 50a′, 50d′ enables this light field reconstruction to extend seamlessly across multiple projector devices, creating a continuous three-dimensional viewing experience despite the mechanical gap 12 between physical projector housings.

The optical shifting of the actual hogel center to an apparent hogel center enables multiple light field projector devices to be positioned adjacent to one another without creating visible seams in the combined light field output. Light rays from hogels near the edges of each projector device are redirected to extend the effective coverage area beyond the physical boundaries of the device housing. This redirection allows the light fields from neighboring projector devices to overlap in the region of the mechanical gap, filling what would otherwise appear as a dark band or discontinuity in the displayed image. The redirection of light rays to shift apparent hogel positions also reduces the mechanical precision required when positioning adjacent projector devices relative to one another as any physical misalignments between projector housings can be compensated optically through controlled angular redirection of light rays at the edges of each device. This optical compensation simplifies the assembly process for large-scale displays by relaxing the tolerances for physical alignment between individual projector units. The controlled redirection of light rays at specified angles maintains consistent spacing between apparent hogel centers across the entire display area, including regions where multiple projector devices meet. Without this optical compensation, the mechanical gap between adjacent projector housings would create a region of increased hogel pitch, disrupting the uniform distribution of light rays. The optical shifting extends the effective coverage of each projector device into the gap region, preserving uniform hogel spacing throughout the combined light field and eliminating spatial discontinuities at device boundaries.

The definition of hogels with associated elemental images and actual hogel centers establishes a spatial reference framework within the display lens. This framework provides the geometric information needed by the reprojection optical component to determine the required angular redirection for each light ray. The actual hogel centers serve as baseline positions from which the optical component calculates the displacement needed to create apparent hogel centers at desired locations, enabling precise control over the perceived hogel distribution across the display plane. The association between each hogel and its actual center location allows the reprojection optical component to apply position-dependent optical transformations across the display lens. Hogels positioned near the edges of the projector device require greater angular redirection to extend the light field coverage into the mechanical gap region, while hogels near the center of the device require less redirection. The defined actual hogel centers provide the spatial coordinates necessary to compute these position-dependent redirection angles, ensuring that the apparent hogel centers are shifted by appropriate amounts to maintain uniform spacing across device boundaries. The establishment of actual hogel centers as reference points enables calculation of the optical path modifications needed to achieve seamless tiling between adjacent projector devices. A reprojection optical component uses the known positions of actual hogel centers to determine the angular deviation required for light rays passing through each hogel-defining element. This calculated deviation shifts the apparent hogel centers outward from their actual positions, extending the effective coverage area of each projector device and allowing light fields from neighboring devices to overlap in the gap region without creating visible discontinuities.

The shifting of apparent hogel centers outward from actual hogel centers by an offset distance extends the effective coverage area of each projector device to the display lens edge. This extension allows light fields from adjacent projector devices to overlap in the mechanical gap region between housings. The optical filling of physical gaps eliminates the need for additional hardware components to bridge the spacing between projector units, simplifying the overall system architecture while maintaining continuous light field coverage across device boundaries.

The concept of an observer-based function based on light in space and time, or plenoptic function, describes visual stimulation perceived by vision systems. The plenoptic illumination function or plenoptic function is an idealized function used in computer vision and computer graphics to express the image of a scene from any possible viewing position at any viewing angle at any point in time. The basic variables of the plenoptic function are dependent upon include the 3D coordinates (x, y, z) from which light is being viewed, and the direction light approaches this viewing location as described by the angles (θ, φ). With wavelength of the light, λ and time of the observation, t, this results in the plenoptic function: P(x, y, z, θ, φ, λ, t). As an alternative to the plenoptic function, the radiance along light rays in 3D space at a point and given direction may be used and represented by a light field. The definition of a light field may be equivalent to that of the plenoptic function. A light field may be described as radiance flowing through all points in all possible directions, as a 5D function. For a static light field, the light field may be represented as a scalar function: L(x, y, z, θ, φ), where (x, y, z) represent the radiance as a function of location and the light direction of travel is characterized by (θ, φ). A viewer of a 3D real world object is subject to infinite views, or a continuously distributed light field, which can be thought of as a vector function that describes the amount of light flowing in every direction through every point in space. To practically replicate this, the present disclosure provides a light field projector display device capable of subsampling the continuously distributed light field into a finite number of views, or multiple views, to approximate the light field. The output of the light field projector device is a light field image, which is a 3D representation of a continuously distributed light field based upon a finite number of views with angular resolution meeting or exceeding that of the human eye.

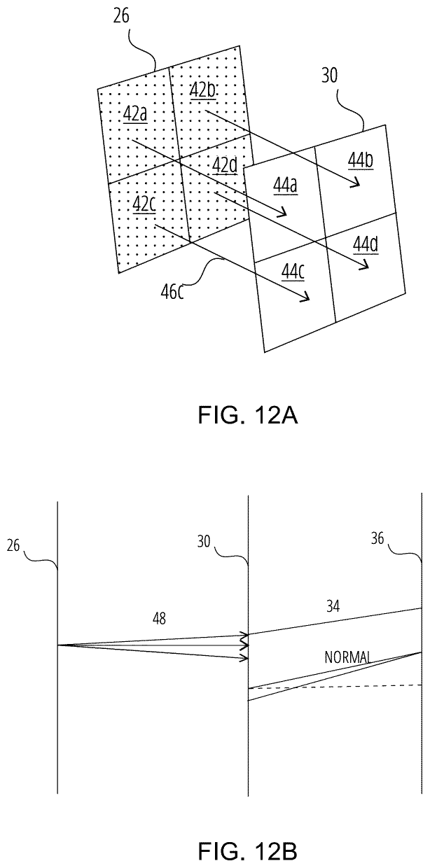

FIG. 12A illustrates an isometric view of a pixel forming device 26 and a reprojection optical component 30. Pixel forming device 26 can be divided into a plurality of hogel regions 42a, 42b, 42c, and 42d, which create a plurality of elemental images, represented by rays in the shown illustration. Elemental images, with elemental image 46c shown as a representative elemental image in the figure, are received by reprojection optical component 30 divided into reprojection hogel regions 44a, 44b, 44c, 44d. A pixel forming device 26, such as an LCOS panel, digital light processing (DLP) chip, or micro-LED array, can create specific elemental images in designated hogel regions 42a, 42b, 42c, 42d by selectively controlling the activation of individual pixels within those regions. Each pixel in the device is individually addressable, meaning it can be programmed to emit or modulate light at a particular intensity and color based on electronic input signals. By defining a pattern of pixel activations confined to a specific area of the device, the desired elemental image can be precisely formed within that region. In an example, in an LCOS panel, the liquid crystals in a defined pixel region can be oriented to reflect light in a specific way, creating a distinct image. Similarly, in a DLP chip, micromirrors in the target region tilt to reflect light into the projection path, generating the elemental image in that area. This capability allows the device to create multiple, non-overlapping elemental images simultaneously or in rapid succession, enabling advanced imaging techniques like holography or tiled displays. The precision of pixel control ensures that the elemental images are accurately localized and do not interfere with adjacent regions, supporting applications requiring high resolution and spatial accuracy. Localized elemental images 46c are then transmitted to respective reprojection hogel regions 44a, 44b, 44c, 44d of the reprojection optical component 30.

An optical component can exhibit different properties in different regions by employing spatially varying materials, structures, or coatings that alter how light interacts with each area. This design allows the component to perform multiple optical functions simultaneously or achieve specific effects tailored to different regions. A metalens, or metasurface, can exhibit different optical properties in different regions by leveraging spatially varying arrangements of its nanoscale structures. These structures, often referred to as meta-atoms, are precisely engineered to manipulate light at subwavelength scales, controlling its phase, amplitude, polarization, or wavelength. By altering the shape, size, orientation, or spacing of these meta-atoms across the surface, the metalens can create regions with distinct optical behaviors. For example, one region of a metasurface might focus light to a specific point, while another region redirects light in a different direction or splits it into multiple beams. This is achieved because each meta-atom imparts a unique phase shift to the incoming light, and by arranging them differently, the metasurface encodes separate optical functions into different areas. Additionally, the metasurface can be designed to interact selectively with specific wavelengths or polarizations of light, enabling one region to reflect certain colors while another transmits them. This spatial programmability allows a single metalens or metasurface to perform complex, multifunctional tasks, such as simultaneous focusing, beam shaping, or wavelength filtering, without the need for bulky, traditional optical components. These properties make metasurfaces highly versatile for applications in imaging, sensing, augmented reality, and advanced optical systems. In one example, in a gradient-index (GRIN) lens, the refractive index changes gradually across the component, enabling light to bend differently depending on the region it traverses. Similarly, in a multifocal lens, different zones are designed with distinct curvatures, allowing the lens to focus light at multiple distances, as seen in progressive eyeglasses or bifocal lenses. In another example, in a diffractive optical element, surface features, such as grooves or gratings, vary in spacing or orientation across the component. This creates regions that diffract light differently, enabling control over the wavelength, direction, or intensity of transmitted light. Coatings, such as anti-reflective or wavelength-selective layers, can also be applied unevenly to create regions with specific optical responses, such as reflecting certain wavelengths while transmitting others. By carefully designing and manufacturing these regional variations, optical components can achieve complex, multi-functional performance in a single element, making them indispensable in advanced display technologies.

FIG. 12B illustrates a simplified cross-sectional view of a single pixel beam 48 emitted by a pixel forming device 26 received by a display lens 36. The single pixel beam 48 received by the reprojection optical component 30 is shifted at a specified redirection angle relative to normal at the reprojection optical component 30. The shifted or angled light rays 34 are transmitted to the display lens 36 off-normal, and thereby focused off-axis.

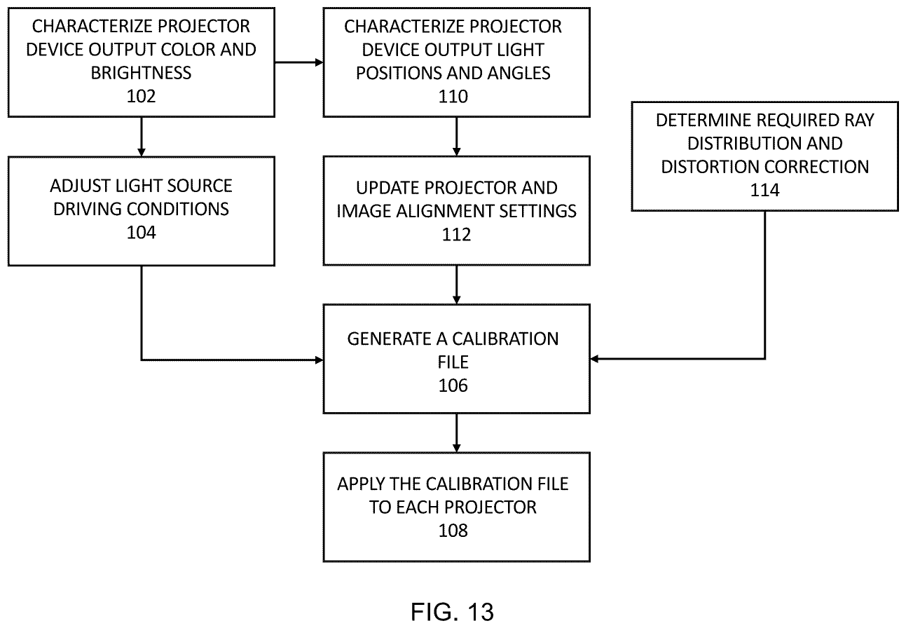

FIG. 13 illustrates a flow diagram for a display calibration procedure, as per the present disclosure. A calibration file is first generated for each projector by characterizing the projector output through the entire color range, image space, and lens configuration of the display. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In a light field display system calibration procedure, calibration files are generated during an initial setup or recalibration process of light field projection systems. Creating a calibration file and calibrating a light field projection system requires specialized software and equipment and are essential for maintaining the system performance over time, particularly in complex setups requiring precise synchronization and alignment. The calibration of each light field projector in a light field display system can alter the LED voltage, current, and mixing ratio to achieve a color uniformity across the light field display while also ensuring that the intensity for each color step is within the specified tolerance value. Projector calibration can be performed with the projectors installed in the light field display system, and/or by calibrating individual projectors before installation using one or more calibrated imaging device such as, for example, a photometer, colorimeter, or Digital Single-Lens Reflex Camera (DSLR). During this stage, optical corrections for distortion, warping, or other projector-based quantities can be applied.

With the light field projector devices installed into the light field display system, the projector digital offset can be determined and set before display characterization and correction. The light field projector frame is illuminated in each projector and the digital offset can be automatically determined through an iterative process using a DSLR. Each projector requires an independent set of values. With the offset values determined, the additional pixels in the projector assigned for overlap with adjacent projectors are illuminated. A default coefficient set is assigned to each projector, noting different coefficients for the outside edge projectors. The coefficients are then updated in an automated procedure to achieve the required blending. The final step is light field display calibration, which is used to measure a pixel-to-pixel correspondence from the projector pixel to the light field pixel.

A calibration method for a light field display system comprising an array of light field projector devices can include, for example, calculating a specified white point value for each light field projector device in the light field display system by characterizing a projector output for each light field projector device by executing a characterization operation for each color of a defined color range for the light field display; generating a calibration file related to the specified white point values for each light field projector device in the light field display; and applying the calibration file to each projector to produce a uniform light field output. In some embodiments the calibration file comprises projector alignment settings, angular light ray distribution corrections, brightness and color adjustments, and lens distortion parameters. In some embodiments applying the calibration file alters the LED voltage, current, and mixing ratio of the light field projector device.

In one example calibration method, each projector device output is first characterized by color and brightness 102. Then the light source driving conditions for each projector are adjusted 104. A calibration file can then be generated for each light field projector 106 and the calibration file can be applied to each light field projector 108. The light field projector output light positions and angles are also characterized 110 and the projector and image alignment settings are updated based on the projector output light positions and angles 112 and added to the calibration file. Ray distribution and distortion correction can also be determined 114 and provided to generate the calibration file 106.

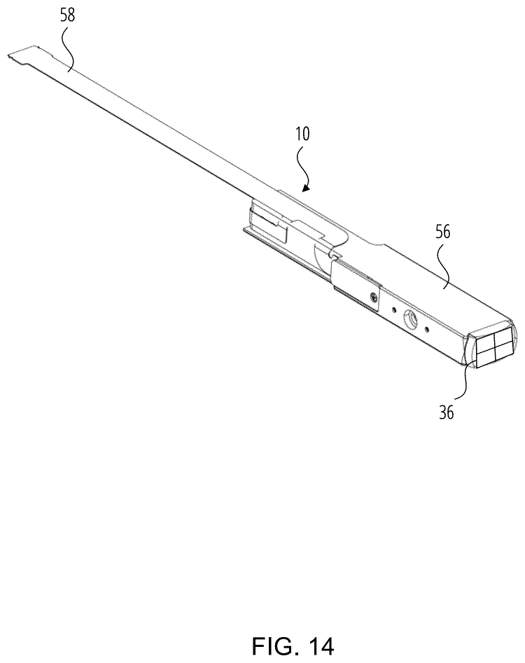

FIG. 14 illustrates an isometric view of a light field projector device 10 as per the present disclosure. All optical components can be contained within projector housing 56, or any other housing or structure that secures the components. A light field image created by a set of LEDs in a projection optical system is projected through the display lens 36 which may comprise a microlens array. A display lens 36 in a light field display is an optical element that directs and focuses light emitted from the display surface to create a three-dimensional visual experience and its primary role is to spatially and angularly distribute light rays reconstructing the light field to produce depth and parallax. Working in tandem with the pixel array, the display lens maps groups of pixels or subpixels to specific viewpoints, allowing observers to perceive different angles of the scene without the need for special glasses. The display lens 36 can be a microlens arrays comprising a plurality of tiny lenses that project light at precise angles for high-resolution light field displays. The precision and design of the display lens are crucial for achieving high-quality 3D imagery and a seamless viewing experience. The light field projector device 10 shown also has a flexible printed circuit 58 (FPC), also referred to as the light field projector flex cable, to connect the light field projector device 10 and light sources to the drive electronics. The light field projector housing 56 serves to house and secure the optical components in the light field projector device 10. Alternative projector body configurations can comprise one or more single surface or structure to which the optical components can be secured or held in place.

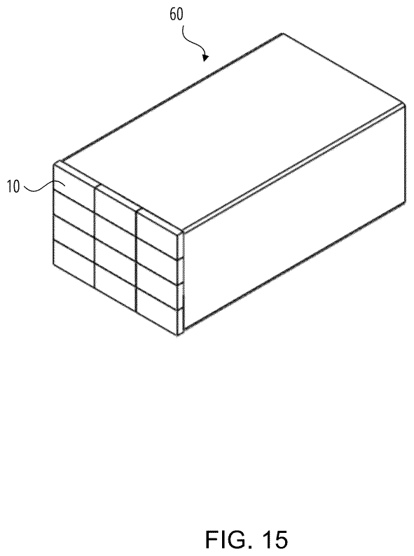

FIG. 15 illustrates a light field display system 60 having an array of light field projector devices 10 arrayed together. Each projector in an array of light field projector devices 10 in a light field display system 60 may be uniformly aligned with one another, with some mechanical gap, and the resulting display will appear to be a consistently spaced set of hogels using the light field projector architecture as presently described. The optical shift outward to the edge of each hogel covers the required physical gap between projector bodies. This enables controlled magnification of the light emitted from each projector which forms the light field, such that light fields formed by neighboring projectors are aligned with little or no border, limiting picket fence effects.

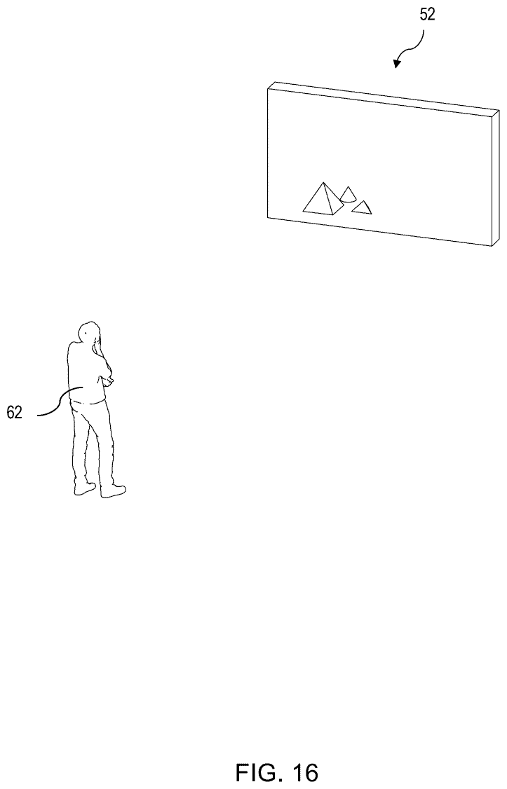

FIG. 16 illustrates an isometric view of a light field display system 52 horizontally mounted display unit. A viewer 62 is positioned in front of a horizontally mounted light field display system 52. The horizontally mounted light field display system 52 comprises an array of light field projector devices arranged in a tiled configuration to form a display system. The horizontally mounted light field display system 52 presents a light field image visible to the viewer 62. The light field display system 52 shown is oriented such that its display surface faces the viewer 62, allowing the viewer 62 to perceive depth, parallax, and three-dimensional visual information without requiring specialized eyewear. The light field projector devices within the horizontally mounted light field display system 52 operate collectively to generate a seamless light field across the display surface. Each light field projector device within the horizontally mounted display includes a pixel forming device that generates light in a pixel array, creating elemental images. A display lens comprising a microlens array receives light from the pixel forming device and creates hogels. A hogel position shifting optical element is positioned after the display lens and is configured to shift apparent positions of the hogels as perceived by the viewer 62. This configuration allows the apparent centers of the hogels to be displaced relative to their physical positions, compensating for mechanical gaps between adjacent projector devices.

The modular arrangement of light field projector devices enables scalability and flexibility in display dimensions and orientation. The viewer 62 can move relative to the horizontally mounted display system, experiencing continuous perspective changes as different angular light information reaches the viewer's eyes from the hogels. The light field projector devices are arranged with uniform spacing, and the hogel position shifting optical element in each device shifts the apparent hogel positions outward toward the edges of each projector device. This shifting compensates for physical gaps between projector housings, ensuring that the hogel pitch remains consistent across the entire horizontally mounted display. Light rays emitted from hogels near the edges of adjacent projector devices converge to fill regions that would otherwise appear as dark seams, thereby producing a continuous light field image across the tiled display. The hogel position shifting optical element redirects light rays to shift the apparent positions of hogels outward toward the edges of each projector device. This optical shifting fills the physical gaps between adjacent projector housings that would otherwise appear as dark seams to the viewer 62. The viewer 62 perceives a continuous light field image without visible boundaries between individual projector devices.

A hogel position shifting optical element in each light field projector in the light field display system 52 maintains consistent hogel spacing across the entire horizontally mounted display system by compensating for mechanical gaps between projector devices. Light rays can thereby be redirected at specified angles to ensure that the apparent hogel pitch remains uniform from one projector device to the next. The viewer 62 experiences a seamless tiled light field image without discontinuities or picket-fence artifacts. The optical compensation provided by the hogel position shifting optical element reduces the precision required for physical alignment of adjacent projector devices. Mechanical gaps between projector housings are optically compensated rather than requiring extremely tight mechanical tolerances. Assembly and installation of the horizontally mounted display unit 64 is simplified while maintaining visual continuity across the tiled display. The optical shifting of apparent hogel positions to projector edges fills dark regions between projectors. Physical gaps between projector housings would otherwise create visible seams in the displayed image. The hogel position shifting optical element redirects light to eliminate these mechanical gap image regions, presenting a continuous visual field to the viewer 62.

The tiled configuration of light field projector devices supports installation of the light field display system 52 in diverse environments. The display system can be arranged as an asymmetric wall display, a curved wall display, a tabletop display, a horizontally mounted display unit, a tiled floor display, or a tiled wall with floor display. This flexibility accommodates different viewing scenarios and spatial constraints. The modular architecture allows multiple light field projector devices to be combined with optical gap compensation. Large-scale displays can be constructed by tiling projector devices in various geometric arrangements. The hogel position shifting optical element maintains light field continuity across the assembled display regardless of the number of projector devices. Different display configurations enable optimization for particular applications. In some examples, immersive entertainment installations may utilize curved wall arrangements, while medical imaging applications may employ tabletop configurations. Holography and augmented reality applications can select display geometries that match their specific viewing requirements.

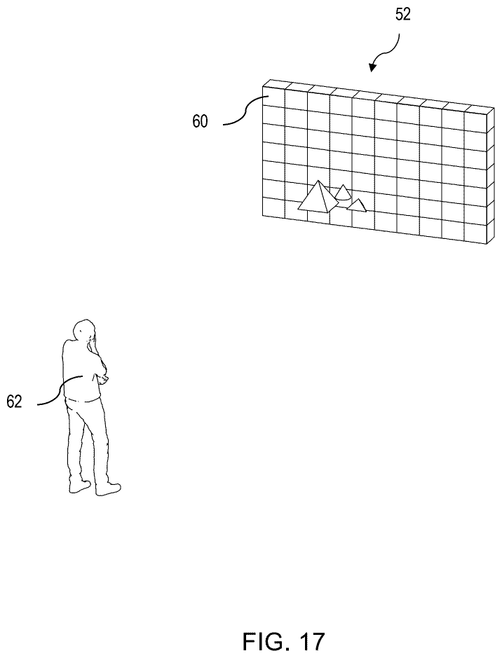

FIG. 17 illustrates a light field display system 52 comprising an array of light field projector arrays 60 arranged to form a tiled wall. A viewer 62 is positioned in front of the tiled wall. The tiled wall comprises an array of light field projector arrays 60 formed of multiple light field projector devices arranged in an array configuration, where each projector device includes a pixel forming device, a hogel position shifting optical element, and a display lens comprising a microlens array. The tiled wall light field display system 52 creates a light field image that is viewable by the viewer 62 from various positions and angles. The light field projector devices within the tiled wall light field display system 52 are arranged in a grid pattern to create a larger composite display surface. Each light field projector device in each light field projector array 60 generates a portion of the overall light field image, and the hogel position shifting optical elements in each device are configured to shift the apparent positions of the hogels to align the light fields from adjacent projector devices. This alignment reduces visible gaps or discontinuities between the individual projector outputs, creating a seamless visual experience for the viewer 62. The tiled wall light field display system 52 operates by coordinating the outputs of the multiple light field projector devices. Each projector device receives image data corresponding to its designated portion of the overall image. The pixel forming devices in each projector generate elemental images that are processed by the hogel position shifting optical elements to create hogels at the display lenses. The hogel position shifting optical elements adjust the apparent positions of the hogels such that the light fields from neighboring projector devices merge without visible seams or borders.

The viewer 62 perceives the tiled wall as a unified light field display rather than as separate projector outputs. The shifting of the apparent hogel positions compensates for the physical spacing between the projector devices, which would otherwise create dark regions or mechanical gap image regions in the displayed image. By shifting the hogels outward toward the edges of each projector device, the light field coverage extends to fill the spaces between adjacent devices. A tiled wall light field display system 52 can be configured in various array sizes depending on the desired display dimensions. The array can comprise rows and columns of light field projector devices, with each device contributing to the overall resolution and viewing angle of the display. The hogel pitch remains uniform across the tiled wall due to the coordinated shifting of hogel positions by the hogel position shifting optical elements in each projector device. The display lens in each light field projector device of the tiled wall may comprise microlens arrays, where each microlens corresponds to a hogel in the light field. The hogel position shifting optical elements may optionally be positioned after the display lenses and modify the apparent spatial distribution of the hogels as perceived by the viewer 62. This modification allows for controlled magnification and positioning of the light emitted from each projector device, facilitating the seamless tiling of the light fields. The viewer 62 can move relative to the tiled wall and observe different perspectives of the displayed light field image. The light field projector devices in the tiled wall emit light rays at various angles corresponding to different viewpoints, enabling the viewer 62 to perceive depth, parallax, and three-dimensional characteristics of the displayed content. The hogel position shifting optical element in each light field projector ensure that the angular distribution of light rays remains consistent across the boundaries between adjacent projector devices.

The optional hogel position shifting optical element in the tiled wall may redirect light from each projector device to extend the light field coverage toward the edges of each device. This redirection causes the apparent hogel positions to shift outward, filling the physical spaces between adjacent projector devices where mechanical gaps would otherwise create dark regions. The viewer 62 perceives continuous light field coverage across the tiled wall without visible seams or interruptions between the individual projector devices. The hogel position shifting optical elements maintain consistent spacing between hogels across the entire tiled wall by redirecting light rays at specified angles. The redirection compensates for the mechanical gaps between projector devices, ensuring that the distance between hogels at the edge of one device and the edge of an adjacent device matches the distance between hogels within a single device. The viewer 62 can thereby observe uniform hogel distribution across the tiled wall without variations in spacing that would create visual artifacts. The hogel position shifting optical elements provide optical compensation for the mechanical gaps between projector devices in the tiled wall. This optical compensation reduces the precision required for physical alignment of the projector devices during assembly and installation. The tiled wall can be constructed with standard mechanical tolerances while the hogel position shifting optical elements adjust the light field coverage to create seamless visual output.

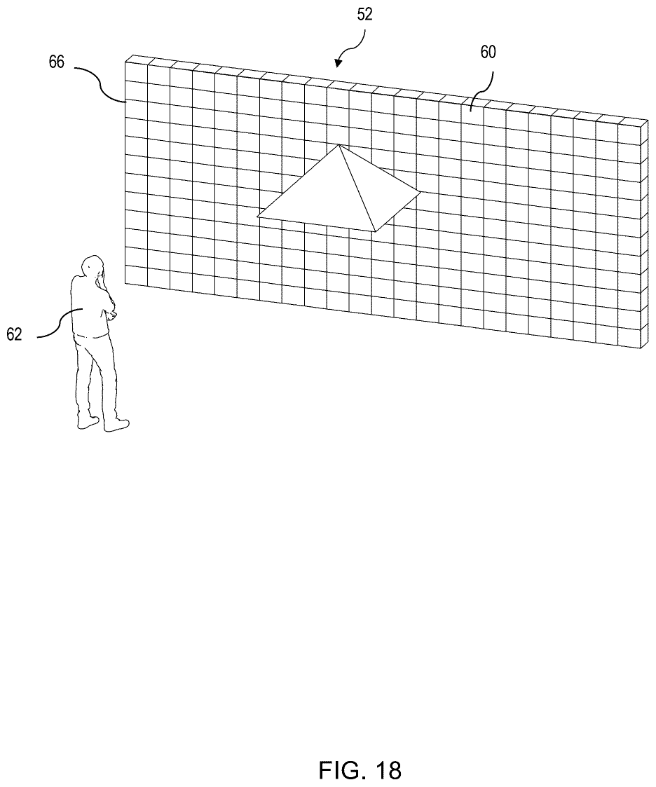

FIG. 18 illustrates a light field display system 52 comprising a tiled wall display 66 and a viewer 62 positioned in front of the display. The tiled wall display 66 is composed of an array of light field projector devices in a light field projector array 60 arranged in a grid pattern to form a larger display surface. Each tile within the light field projector array 60 comprises multiple light field projector devices, with each projector device configured according to the device described elsewhere herein. The arrangement of projector devices in the tiled wall display 66 allows for the creation of an extended light field image that spans across the entire display surface. A light field image is generated by the collective output of the individual light field projector devices within the tiled wall. Each projector device contributes to the overall light field by emitting light rays that are spatially and angularly distributed to recreate the appearance of a three-dimensional object or scene. The viewer 62 perceives depth, parallax, and realistic three-dimensional imagery as they observe the tiled wall from various positions and angles.

The tiled wall display 66 comprises multiple light field projector devices arranged in both horizontal and vertical directions. Each light field projector device within the array generates a portion of the overall light field, with the individual light fields from adjacent projectors being aligned to create a seamless visual experience. The hogel position shifting optical capability in each projector device shifts the apparent positions of the hogels such that the light fields from neighboring projectors align with minimal or no visible borders between tiles. This configuration reduces the mechanical gap image region that would otherwise appear as dark lines or seams between adjacent projector devices. The pixel forming device in each light field projector device generates light in a pixel array that creates elemental images. In each light field projector the display lens, comprising a microlens array, receives light from the pixel forming device and creates hogels. For hogels near the edges of each projector device, the redirection angles are larger relative to normal, which shifts the apparent hogel center outward toward the physical edge of the display lens. This optical shift covers the mechanical gap between adjacent projector bodies, allowing the light fields from neighboring projectors to tile together seamlessly.

In each light field projector, a reprojection optical element, a hogel position shifting optical element or a hogel defining element redirects light rays from hogels near the edges of each projector device, causing the apparent hogel positions to shift outward toward the physical boundaries of the display lens. This optical redirection causes the light fields from adjacent projector devices to overlap in the regions where mechanical gaps exist between the physical housings. The shifted hogel positions fill the spaces that would otherwise appear as dark seams, creating a continuous light field across the entire tiled display surface. The redirection of light rays at specified angles maintains consistent spacing between hogels across the boundaries where multiple projector devices meet. Without this optical compensation, the mechanical gaps between projector housings would create regions of increased hogel pitch, resulting in visible discontinuities in the light field. The optical shifting ensures that the hogel spacing remains uniform throughout the display, producing a seamless visual appearance without variations in spatial resolution. The optical compensation provided by the hogel position shifting elements reduces the precision required for physical positioning of adjacent projector devices within the tiled array. Mechanical tolerances in the mounting and alignment of projector housings can be accommodated through the optical redirection of hogels. This approach simplifies the construction and installation process for large-scale tiled light field displays, as minor variations in projector placement are optically corrected rather than requiring extremely tight mechanical specifications.

The viewer 62 is positioned at a distance from the tiled wall display 66 that allows for comfortable viewing of the light field image. The viewer 62 can move laterally or vertically relative to the tiled wall display 66, and as they do so, their perceived perspective of the three-dimensional image changes due to the parallax effect provided by the light field. The tiled wall display 66 provides a wide viewing angle, enabling multiple viewers to observe the light field image simultaneously from different positions. The light field display system 52 shown in FIG. 18 is suitable for applications such as immersive entertainment, holographic visualization, augmented reality, and other scenarios where high-fidelity three-dimensional imagery is desired. The tiled wall display 66 can be scaled to various sizes by adjusting the number of projector devices in the array. The modular nature of the light field display system 52 allows for flexibility in display dimensions, with the ability to create large-scale displays by adding more projector devices to the array. A housing or support structure holds the projector devices in place within the tiled wall, ensuring precise alignment and spacing between adjacent devices. The controlled magnification of the light emitted from each projector device, combined with hogel position shifting capability, enables the tiled wall to present a continuous light field image without visible tiling artifacts or picket fence effects.

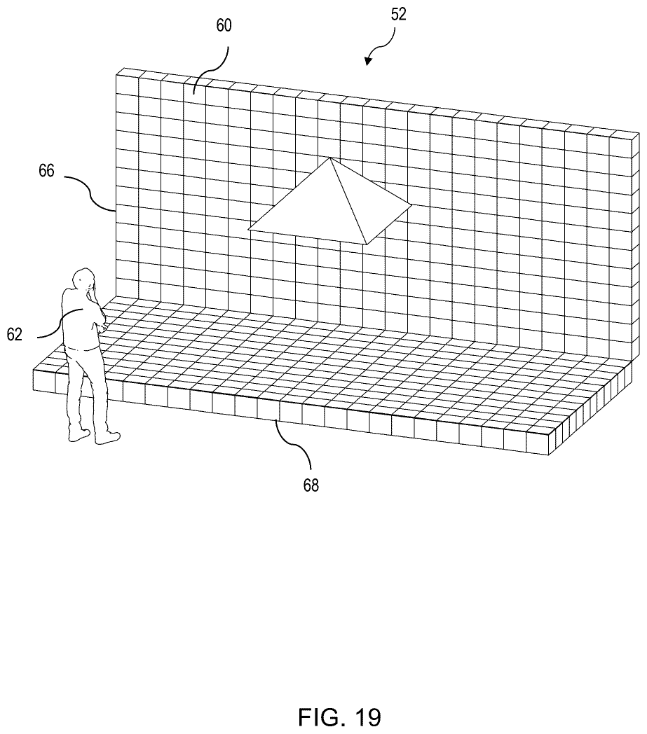

FIG. 19 illustrates a light field display system 52 arranged in a tiled wall and floor configuration. The system comprises a plurality of light field projector devices arranged to form both a tiled wall display and a tiled floor display 68. The tiled wall display 66 is positioned vertically, while the tiled floor display 68 extends horizontally from the base of the wall display. A viewer 62 is shown positioned in front of the combined display configuration, able to observe the light field images generated by both the wall and floor components. The tiled wall display 66 comprises multiple light field projector devices arranged in an array. Each projector device in the array generates light fields that are aligned and blended to create a seamless visual experience across the entire wall surface. The grid pattern visible on the tiled wall display 66 represents the arrangement of individual light field projector devices, with each grid section corresponding to a single projector unit. The projector devices are positioned adjacent to one another, with physical spacing between units to accommodate projector housings and mounting structures. The tiled floor display 68 similarly comprises an array of light field projector devices arranged in a light field projector array 60, arranged horizontally. The floor display 68 extends outward from the base of the wall display, creating a continuous light field environment that encompasses both vertical and horizontal surfaces. The grid pattern on the floor display 68 indicates the layout of individual light field projector arrays 60 within the floor array. Each projector device in each light field projector array 60 in the tiled floor display 68 operates using the same optical configuration as those in the tiled wall display 66, generating hogels through pixel forming devices, reprojection optical components, and display lenses.

The configuration shown provides an asymmetric arrangement where the tiled wall display 66 and tiled floor display 68 meet at an angle, forming an L-shaped viewing environment. This arrangement allows the viewer 62 to experience light field images that span across multiple surfaces, creating an immersive visual environment. The light field projector devices in both the wall and floor arrays are calibrated to ensure consistent hogel spacing and uniform brightness across the entire display system. The viewer 62 is positioned at a distance from the displays where the light fields generated by the projector arrays converge to create coherent three-dimensional images. The viewer 62 can observe different perspectives of the displayed content by moving relative to the display surfaces. The light rays emitted from each hogel in the display system reach the viewer's eyes at specific angles, providing depth perception and parallax effects without requiring specialized viewing equipment. The tiled configuration allows for scalable display systems where the size and shape of the display can be customized by adding or removing projector devices from the array. The wall display can extend vertically and horizontally to cover larger areas, while the floor display 68 can extend further outward to create larger horizontal viewing surfaces. The modular nature of the system enables adaptation to various installation environments and viewing requirements.

Each light field projector device in the tiled wall display 66 and tiled floor display 68 includes components for generating and directing light rays at specified angles. Each light field projector in the light field display system 52 contains a light source, projection optical systems, pixel forming devices, reprojection optical components, and display lenses. The reprojection optical components in each light field projector device redirect light rays at redirection angles that shift the apparent positions of hogels, compensating for the physical spacing between adjacent projector units. The hogel position shifting provided by the reprojection optical components enables the system to maintain uniform hogel pitch across the boundaries between adjacent projector devices. Light rays from hogels near the edges of each projector device are redirected at larger angles relative to hogels near the center of the projector device. This angular distribution creates an optical shift that extends the effective coverage area of each projector device, filling gaps that would otherwise appear as dark regions between projectors. A hogel position shifting optical element in each light field projector can also address visibility issues that arise from physical spacing between adjacent projector devices in the tiled configuration. When multiple projector devices are arranged in an array, mechanical gaps exist between units to accommodate housings and mounting structures. The optical element redirects light rays at specified angles to shift the apparent positions of hogels outward, causing the light fields from adjacent projectors to overlap and fill these physical gaps. This redirection creates continuous light field coverage across the display surface, eliminating dark regions that would otherwise appear between projector units. A hogel position shifting optical element in each light field projector maintains consistent spacing between hogels across the entire display system despite the presence of mechanical gaps between projector devices. Light rays from hogels positioned near the edges of each projector device are redirected at angles that extend the effective coverage area of that device. This angular redirection ensures that the spacing between hogels at the boundary of one projector device matches the spacing between hogels within a single projector device. The resulting uniformity in hogel distribution prevents discontinuities in the displayed light field images where adjacent projectors meet. The optical compensation provided by the hogel position shifting optical element reduces constraints on the physical positioning of projector devices within the array. Precise mechanical alignment between adjacent projectors becomes less demanding because the optical element compensates for variations in spacing and positioning. The system can tolerate larger mechanical gaps and positioning tolerances while still producing seamless light field images. This flexibility streamlines the assembly process for large-scale display installations and reduces installation complexity.

The tiled configuration of light field projector devices eliminates visible mechanical gap image regions through optical shifting of apparent hogel positions. The reprojection optical components redirect light rays at specified angles, extending the effective coverage area of each projector device to the edges of adjacent units. This optical compensation fills dark regions that would otherwise appear between projector housings, creating continuous light field coverage across the entire display surface without visible interruptions. The arrangement of light field projector devices in various configurations enables installation in diverse environments and viewing scenarios. The system supports vertical wall displays, horizontal floor displays, combined wall-floor displays, curved surfaces, tabletop orientations, and asymmetric arrangements. Each configuration provides viewing geometries suited to specific installation spaces and user interaction requirements. The combined wall and floor display configuration creates a continuous light field environment where images can span across both wall and floor surfaces. Content displayed on the system can include objects that appear to rest on the floor display 68 while extending upward into the wall display. The seamless integration between the two display surfaces is achieved through careful calibration of the projector devices in both arrays, ensuring consistent brightness, color, and hogel alignment across the transition between wall and floor. The system supports dynamic content where images can move across the display surfaces in response to viewer position or programmed sequences. The viewer 62 can interact with the displayed content by moving around the viewing area, experiencing changes in perspective as different hogels become visible from different viewing positions. The light field display system provides full parallax, allowing the viewer 62 to observe horizontal and vertical perspective changes as they move relative to the displays.

The modular architecture of multiple tiled light field projector devices supports construction of large-scale displays in various geometric arrangements. The system maintains seamless light field continuity across projector boundaries through optical gap compensation and calibrated hogel alignment. Display size and shape can be customized by adding or removing projector devices from the array, enabling scalable installations that adapt to available space and viewing requirements. The support for multiple display configurations enables optimization for specific application requirements. Vertical wall displays suit immersive entertainment and visualization applications where viewers observe from a standing position. Horizontal tabletop and floor displays accommodate collaborative viewing scenarios where multiple users gather around a shared surface. Combined wall-floor configurations create environments for applications requiring extended viewing areas across multiple surfaces.

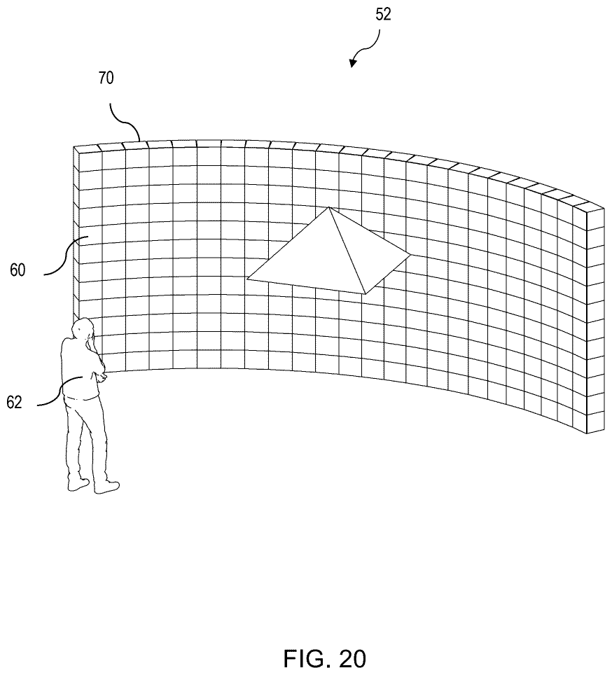

FIG. 20 illustrates a light field display system 52 comprising multiple light field projector devices arranged in a light field projector array 60, with a plurality of light field projector arrays 60 tiled to create a curved wall configuration 70. The curved wall configuration 70 presents the light field display system 52 in a concave arrangement, where the display surface curves inward toward a viewer 62. This arrangement provides an immersive viewing experience by surrounding the viewer 62 with the light field display across a wide angular range. The curved wall configuration 70 comprises a plurality of light field projector devices positioned adjacent to one another to form the curved surface. Each light field projector device includes a pixel forming device, a reprojection optical component, and a display lens comprising a microlens array. The hogel position shifting optical element in each projector device shifts the apparent positions of the hogels to compensate for the mechanical gaps between adjacent projector devices. This shifting allows the light fields from neighboring projectors to align seamlessly, creating a continuous light field display across the curved surface. In the curved wall configuration 70, the light field projector devices can be arranged in rows and columns, with each device oriented to follow the curvature of the wall. The curvature can be cylindrical, spherical, or follow another curved geometry depending on the desired viewing characteristics. The hogel position shifting optical elements in each projector device are calibrated to account for the varying angles and positions of the projectors relative to the viewer 62. This calibration ensures that the hogel pitch remains uniform across the entire curved display, maintaining consistent spatial and angular resolution throughout the light field.

The viewer 62 is positioned at a distance from the curved wall configuration 70 where the light field can be perceived. From this viewing position, the viewer 62 experiences depth, parallax, and realistic three-dimensional images as they move relative to the display. The curved arrangement enhances the field of view available to the viewer 62, allowing them to perceive the light field across a broader angular range than would be possible with a flat display configuration. The curvature also reduces the viewing distance required for immersive experiences, as the display wraps around the viewer's field of vision. The arrangement of light field projector devices in the curved wall configuration 70 can be customized based on the application requirements. The number of projector devices, the degree of curvature, and the spacing between devices can be adjusted to achieve the desired display size and resolution. The hogel position shifting optical elements in each device are configured to provide seamless tiling across the selected configuration, ensuring that the mechanical gaps between projectors do not create visible discontinuities in the light field. The curved wall configuration 70 can be implemented in various settings, including entertainment venues, simulation environments, medical imaging facilities, and augmented reality installations. The immersive nature of the curved display makes it suitable for applications where a wide field of view and high-fidelity three-dimensional visualization are beneficial. The calibration of the hogel position shifting optical elements allows the system to maintain uniform image quality across the entire curved surface, regardless of the complexity of the curvature or the number of projector devices in the array.

The calibration of the hogel position shifting optical elements according to the curved wall configuration 70 enables seamless tiling across the display geometry. The calibration process adjusts the optical shifting parameters in each projector device to account for the specific curvature and arrangement of the array. This configuration-specific calibration ensures that the light field transitions smoothly between adjacent projector devices, regardless of whether the surface is cylindrical, spherical, or follows another curved geometry. The calibration method applies to multiple configuration types beyond the curved wall configuration 70, including asymmetric walls, tabletop arrangements, horizontal mountings, tiled floors, and combined wall-floor installations. A unified approach to calibrating the hogel position shifting optical elements simplifies the deployment process across different installation environments. The same calibration principles can be adapted to each configuration type, reducing the complexity of system setup and allowing the light field display system to be reconfigured for different applications. The calibration of the hogel position shifting optical elements in each light field projector optimizes the optical gap compensation for the specific geometric arrangement of the curved wall configuration 70. The calibration accounts for the varying angles and positions of projector devices relative to the viewer 62 and to one another. This adaptive optical compensation maintains uniform hogel pitch throughout the curved display, ensuring consistent spatial and angular resolution across the entire light field regardless of the display shape.

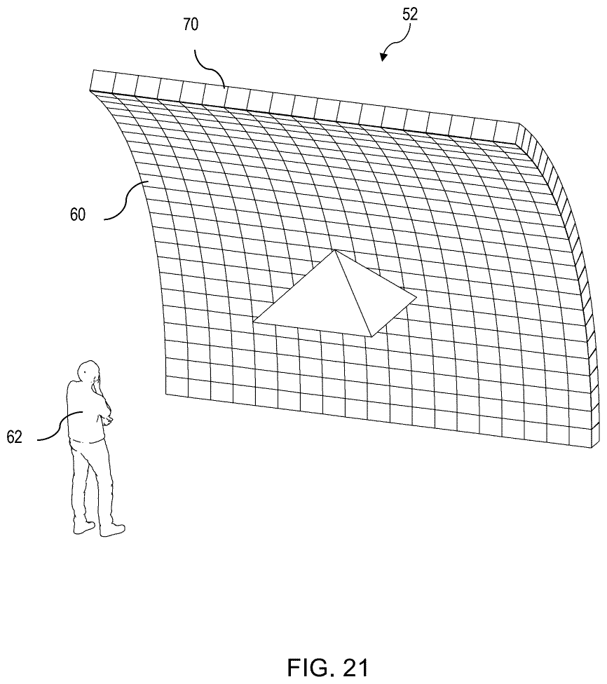

FIG. 21 illustrates a light field display system 52 comprising multiple light field projector devices arranged in a light field projector array 60, with each light field projector array 60 tiled to create a curved wall configuration 70 with a vertical overhang extending beyond the base of the display. A viewer 62 is positioned in front of the curved wall configuration 70. The curved wall configuration 70 comprises multiple light field projector devices arranged in a tiled array, with each tile comprising an array of individual light field projector devices. The configuration includes a curvature that extends upward and outward, creating an overhanging portion that projects toward the viewing space. The curved wall configuration 70 with vertical overhang provides an extended viewing volume compared to configurations without an overhang. The overhanging portion allows the display to project light field information into a broader spatial region, enabling the viewer 62 to experience the light field from positions closer to the display surface. This arrangement enhances the immersive characteristics of the display by surrounding the viewer 62 with light field content across both horizontal and vertical dimensions. The light field projector devices within the curved wall configuration 70 are arranged to follow the contour of the curved and overhanging surface. Each light field projector device includes a pixel forming device, a reprojection optical component, and a display lens comprising a microlens array. The hogel position shifting optical elements in each projector device shift the apparent positions of hogels to compensate for mechanical gaps between adjacent devices. This optical compensation maintains uniform hogel pitch across the entire curved and overhanging surface, ensuring consistent spatial and angular resolution throughout the display.

The vertical overhang in the curved wall configuration 70 creates viewing angles that differ from those in purely vertical or cylindrical configurations. The overhanging portion directs light rays downward and outward toward the viewer 62, allowing the display to present light field information from elevated positions. The calibration of the hogel position shifting optical elements accounts for these varying projection angles, ensuring that the light field transitions smoothly across the boundaries between projector devices regardless of their orientation within the curved and overhanging geometry. The tiled arrangement of light field projector devices in the curved wall configuration 70 allows for scalable display sizes. Additional projector devices can be added to extend the dimensions of the curved surface or to increase the degree of overhang. The hogel position shifting optical elements in each added device are calibrated to maintain seamless tiling with adjacent devices, ensuring that the expanded display retains uniform image quality across the entire surface. The viewer 62 perceives depth, parallax, and three-dimensional images from the curved wall configuration 70 with vertical overhang. The overhanging portion enhances the field of view available to the viewer 62, particularly in the upper regions of the display. This configuration is suitable for applications where overhead content presentation is beneficial, such as immersive entertainment environments, simulation systems, or architectural visualization installations where spatial context from multiple vertical angles enhances the viewing experience.

The curved wall configuration 70 with vertical overhang can be combined with other display configurations to create complex multi-surface installations. The same calibration principles applied to the hogel position shifting optical elements enable seamless integration between the overhanging section and adjacent display sections, whether those sections are vertical, horizontal, or curved in different directions. This flexibility allows the light field display system to be adapted to diverse installation environments and application requirements.

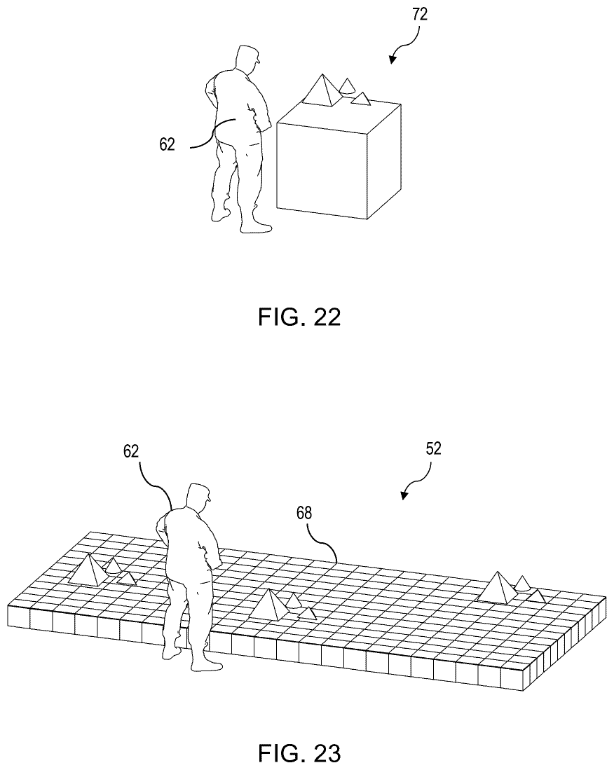

FIG. 22 illustrates a light field display system arranged as a tabletop display 72. The tabletop display 72 comprises an array of light field projector devices configured in a tiled arrangement. The display surface is oriented horizontally, with the light field projecting upward from the tabletop display 72 to provide a viewing experience for a viewer 62 positioned adjacent to the display. In this configuration, the tabletop display 72 allows the viewer 62 to observe three-dimensional light field content from various positions around the display. The horizontal orientation of the display enables the viewer 62 to interact with the light field from multiple viewing angles, experiencing depth, parallax, and realistic three-dimensional imagery without requiring specialized eyewear. The tabletop display 72 can be used in applications such as interactive visualization, collaborative design, medical imaging, and immersive entertainment, where multiple viewers may observe the display simultaneously from different positions. The light field projector devices within the tabletop display 72 each generate hogels that collectively form a continuous light field. The hogel position shifting optical element in each projector device shifts the apparent positions of the hogels, allowing the light fields from adjacent projector devices to align seamlessly. This alignment reduces visible boundaries between projector devices and provides a uniform viewing experience across the entire display surface.

The tabletop display 72 can be scaled to various sizes by adjusting the number of light field projector devices in the array. Larger tabletop displays can be created by increasing the number of projector devices, while smaller displays can be achieved by reducing the array size. The modular nature of the tiled configuration allows for flexibility in display dimensions to accommodate different application requirements and physical space constraints. The viewer 62 can move around the tabletop display 72 to observe the light field from different perspectives. As the viewer 62 changes position, the angular distribution of light rays from the hogels provides different views of the three-dimensional content, creating a dynamic and interactive viewing experience. The continuous light field enables smooth transitions between viewing positions without abrupt changes in image quality or perspective.

The hogel position shifting optical element in each light field projector in the light field display system redirects light rays to shift the apparent positions of hogels toward the edges of each projector device. This optical shifting compensates for physical gaps between adjacent projector devices in the tiled array. The shifted hogel positions create an optically continuous light field across the tabletop display 72, eliminating dark seams that would otherwise appear at the boundaries between projector devices. The hogel position shifting optical element maintains consistent spacing between hogels across the entire tabletop display 72. Without this optical element, mechanical gaps between projector devices would create irregular hogel spacing at the boundaries, resulting in visible discontinuities in the light field. The optical redirection ensures uniform hogel pitch throughout the display, producing seamless three-dimensional imagery for the viewer 62. The optical compensation provided by the hogel position shifting optical element reduces the precision required for physical alignment of the projector devices in the tabletop display 72. Mechanical gaps between projector devices are optically bridged rather than requiring elimination through precise mechanical positioning. This approach simplifies the assembly process and allows for practical installation of large-scale tiled configurations. The tiled configuration of light field projector devices in the tabletop display 72 eliminates visible mechanical gap image regions through optical shifting of hogel positions. The hogel position shifting optical element redirects light to create apparent hogel positions at projector edges, filling regions that would otherwise appear as dark seams between adjacent devices. This optical approach produces a continuous light field across the entire display surface without visible boundaries at mechanical interfaces.

The tabletop display 72 demonstrates one of several possible display form factors achievable through tiled arrangements of light field projector devices. Alternative configurations include asymmetric wall displays, curved wall displays, horizontally mounted displays, tiled floor displays, and combined wall-floor displays. These varied geometric arrangements enable installation in diverse environments and support different viewing scenarios based on application requirements. The modular architecture of the tabletop display 72 allows construction of displays at various scales by adjusting the number of projector devices in the array. Additional projector devices can be added to expand the display area while maintaining seamless light field continuity through optical gap compensation. This scalability supports both compact installations and large-scale displays in different geometric configurations. Different display geometries serve specific application needs by optimizing viewing conditions for particular use cases. The horizontal orientation of the tabletop display 72 facilitates collaborative viewing and interaction from multiple positions around the display. Other configurations such as vertical wall displays or floor-mounted arrangements provide viewing geometries suited to immersive entertainment, medical imaging, holography, and augmented reality applications.

FIG. 23 depicts a light field display system 52 configured to create a tiled floor light field display 68. The system comprises multiple light field projector devices arranged in an array configuration to form a floor-based display surface. A human figure is shown for scale, standing on the display surface, illustrating the physical dimensions and viewing context of the system. The display surface comprises individual tiles, with each tile incorporating an array of light field projector devices that collectively generate a continuous light field across the entire floor area. The tiled floor light field display 68 enables large-scale light field visualization by combining multiple light field projector devices. Each tile in the system contains an array of projector devices, wherein each projector device comprises a light source, a projection optical system, a pixel forming device, a reprojection optical component, and a display lens. The projection optical system receives light from the light source and directs it into a single ray path. The pixel forming device converts this light into a pixel array, creating elemental images that define hogels. The reprojection optical component receives these elemental images, refocuses the light rays, and redirects them at specified redirection angles. The display lens, positioned to receive the redirected light rays, generates the light field that forms the visible display output.

The floor-based configuration allows viewers to interact with the light field display from above, creating applications where three-dimensional imagery can be viewed while walking across or standing on the display surface. The arrangement of multiple tiles extends the display area beyond what a single projector device can provide, enabling visualization of large-scale scenes or data. The tiles are positioned adjacent to one another, with mechanical gaps between individual projector devices within each tile and between the tiles themselves. To address the mechanical gaps between light field projector devices, the reprojection optical component in each light field projector redirects light rays at angles that shift the apparent hogel center. For hogels positioned near the edges of each projector device, the redirection angles are larger relative to normal incidence, causing the light field to extend outward toward the physical boundaries of the device. This optical shifting compensates for the physical spacing between projector devices, allowing the light fields from adjacent devices to align without visible dark bands or discontinuities. The result is a seamless light field image across the entire tiled surface, where the hogel pitch remains uniform despite the presence of mechanical gaps.

The light field display system 52 may include a housing structure that holds the light field projector devices in place, maintaining precise alignment between devices and tiles. The housing provides mechanical support for the display surface and ensures that the projector devices remain positioned at the specified spacing and orientation. Flexible printed circuits connect the projector devices to drive electronics, supplying power and control signals to the light sources and pixel forming devices. The drive electronics coordinate the operation of all projector devices in the array, synchronizing the generation of elemental images across the system to produce a coherent light field display. Calibration of the tiled floor display 68 involves characterizing the output of each projector device to ensure uniform color, brightness, and angular light distribution across the entire display. A calibration file is generated for each projector device by measuring its output across the defined color range and characterizing the spatial and angular properties of the emitted light. The calibration file contains projector alignment settings, corrections for angular light ray distribution, brightness and color adjustments, and lens distortion parameters. Applying the calibration file to each projector device alters the LED voltage, current, and mixing ratio, producing uniform output across the system. The calibration process may utilize calibrated imaging devices such as photometers, colorimeters, or digital single-lens reflex cameras to measure and verify the output. The floor-based display configuration provides a viewing experience where the light field extends across a horizontal plane, allowing multiple viewers to observe the display simultaneously from different positions. The light field generated by the system provides depth and parallax, enabling viewers to perceive three-dimensional imagery without requiring specialized eyewear. The tiled arrangement allows the system to be scaled to larger display areas by adding additional tiles, each containing an array of light field projector devices. The modular design facilitates installation and maintenance, as individual tiles or projector devices can be replaced or adjusted without affecting the entire system.

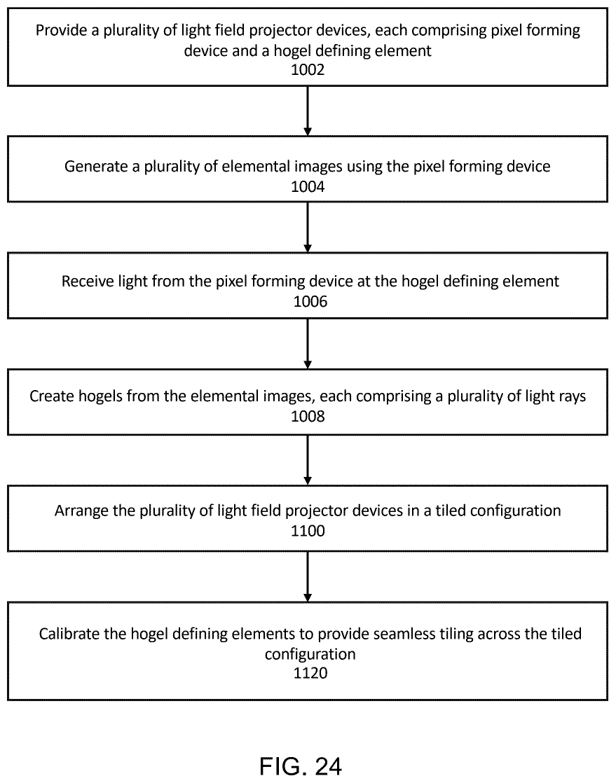

FIG. 24 presents a method for creating a light field display using multiple light field projector devices arranged in a tiled configuration. The method addresses the challenge of achieving seamless visual continuity when physical gaps exist between adjacent projector units. The sequence of operations transforms light from individual sources into a unified light field that spans multiple projector devices without visible discontinuities at device boundaries. Block 1002 provides a plurality of light field projector devices, each projector device having a pixel forming device and a hogel defining element. The pixel forming device converts incoming light into a structured pixel array. The hogel defining element receives light from the pixel forming device and processes it to create hogels. Each hogel comprises multiple light rays distributed across different angles, enabling directional light emission for three-dimensional viewing. The projector devices are constructed as modular units that can be positioned adjacent to one another to form larger display arrays. At block 1004 elemental images are generated using the pixel forming device in each projector device. The pixel forming device modulates light at individual pixel locations to create spatial patterns of intensity and color. Groups of pixels form elemental images, with each elemental image corresponding to a specific hogel. The pixel forming device may comprise a liquid crystal display, organic light-emitting diode display, microLED array, digital micromirror device, liquid crystal on silicon panel, or quantum dot-based display technology. The elemental images contain the directional light information needed to reconstruct three-dimensional visual content at the hogel defining element.

At block 1006 light from the pixel forming device is received at the hogel defining element. Light rays carrying the elemental image information travel from the pixel array to the hogel defining element. The hogel defining element comprises optical structures positioned to intercept and process the incoming light rays. The spatial correspondence between elemental images at the pixel forming device and optical structures at the hogel defining element determines which light rays are processed by each portion of the hogel defining element. This correspondence ensures that each elemental image is directed to its associated hogel-forming optical structure. At block 1008 hogels are created from the elemental images. The hogel defining element processes light from each elemental image to form a hogel that emits light rays in multiple directions. Each hogel functions as a discrete light-emitting element within the overall light field. The hogel defining element may comprise a microlens array where individual microlenses focus and direct light from corresponding elemental images, or a lenticular lens array that directs light along specific angular distributions. The angular spread of light rays from each hogel provides the directional information that enables viewers to perceive depth and parallax when observing the display from different positions.

Block 1100 arranges the plurality of light field projector devices in a tiled configuration. The projector devices are positioned adjacent to one another in a geometric pattern that forms a larger composite display surface. The arrangement may comprise rows and columns of projector devices, or alternative geometric configurations suited to specific installation requirements. Physical spacing exists between adjacent projector devices due to housing dimensions and mounting structures. This mechanical gap between devices creates regions where light coverage would otherwise be absent, potentially resulting in visible seams or dark bands in the displayed image. Block 1120 calibrates the hogel defining elements to provide seamless tiling across the tiled configuration. The calibration process adjusts the optical characteristics of the hogel defining elements in each projector device to compensate for mechanical gaps between adjacent units. The calibration may modify the angular distribution of light rays emitted from hogels positioned near the edges of each projector device, shifting the apparent positions of these hogels outward toward device boundaries. This optical shifting extends the effective coverage area of each projector device, allowing light fields from neighboring devices to overlap in regions where mechanical gaps exist.

The calibration process characterizes the output of each projector device by measuring its light emission characteristics across spatial positions and angular directions. Measurements determine the actual positions of hogel centers at the hogel defining element and the angular distribution of light rays emitted from each hogel. The calibration calculations determine the optical adjustments needed to shift apparent hogel positions such that uniform hogel spacing is maintained across boundaries between adjacent projector devices. The calibration data is stored in a calibration file for each projector device, containing parameters that control the operation of the pixel forming device and any adjustable optical elements within the hogel defining element. Application of the calibration file to each projector device adjusts the light output to achieve the desired optical shifting of hogel positions. The adjustments may include modifications to the voltage, current, or mixing ratios applied to light sources within each projector device, or changes to the content displayed at the pixel forming device to pre-compensate for optical characteristics of the hogel defining element. The calibrated system produces a light field where hogel spacing remains consistent across the entire tiled display, with light from edge hogels of adjacent projector devices converging to fill mechanical gaps without creating visible discontinuities.

The method enables construction of large-scale light field displays by tiling multiple projector devices while maintaining visual continuity across device boundaries. The optical compensation provided through calibration of the hogel defining elements eliminates the need for sub-millimeter precision in mechanical positioning of adjacent projector devices. The tiled configuration supports scalable display systems where additional projector devices can be added to expand display dimensions, with each added device undergoing calibration to integrate seamlessly with existing units in the array. The hogel defining elements direct light rays at specified angles that vary depending on the position of each hogel within the projector device. Hogels positioned near the center of a projector device emit light rays at angles that maintain their apparent positions close to their physical locations at the hogel defining element. Hogels positioned near the edges of a projector device emit light rays at angles that shift their apparent positions outward toward device boundaries. This position-dependent angular control creates the optical magnification effect that extends light field coverage into mechanical gap regions between adjacent projector devices.

The seamless tiling achieved through calibrated hogel defining elements produces a continuous light field across the tiled configuration without visible artifacts at device boundaries. Viewers perceive uniform hogel spacing and consistent image quality throughout the display area. The light field provides three-dimensional viewing characteristics with depth perception and parallax across the entire tiled display, enabling immersive visual experiences suitable for applications including holographic visualization, medical imaging, augmented reality, and large-scale three-dimensional content presentation. The calibration of hogel defining elements provides a structured approach to achieving visual continuity across multiple projector devices without requiring extreme mechanical precision in device positioning. The optical adjustments compensate for physical gaps between adjacent units by modifying the angular distribution of light rays from edge hogels, shifting their apparent positions to maintain uniform spacing across device boundaries. This optical compensation eliminates the need for sub-millimeter positioning accuracy during installation, simplifying the assembly process while ensuring consistent image quality throughout the tiled display. The modular construction of projector devices and the calibration process enable scalable display systems where additional units can be integrated to expand display dimensions. Each added projector device undergoes calibration to determine the optical adjustments needed for seamless integration with existing units in the array. The calibration data for each device ensures that light fields from neighboring projector devices overlap appropriately in gap regions, maintaining uniform hogel spacing and visual continuity as the display area grows.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A light field projector device comprising:
a light source;
a projection optical system to receive light from the light source and direct the light into a single ray path; and
a light field optical system comprising:
a pixel forming device to receive light from the projection optical system and convert the light into a pixel array to create a plurality of elemental images, each elemental image comprising a plurality of light rays; and
a hogel defining element for receiving the light rays from each of the plurality of elemental images, defining a plurality of hogels, each hogel having an associated elemental image, and creating a light field.

2. The light field projector device of claim 1, wherein the light source comprises a plurality of light emitting diodes.

3. The light field projector device of claim 2, wherein the plurality of light emitting diodes emits red, green or blue light.

4. The light field projector device of claim 1, further comprising a plurality of light sources, wherein at least one of the plurality of light sources comprises more than one LED of at least two different colors.

5. The light field projector device of claim 1, wherein the pixel forming device comprises one of a Liquid Crystal Display (LCD), Organic Light-Emitting Diode (OLED), microLED, Digital Micromirror Device (DMD), Liquid Crystal on Silicon (LCoS), and a quantum dot-based panel.

6. The light field projector device of claim 1, wherein the hogel defining element is a microlens array, a lenticular lens, a metalens, or a combination thereof.

7. The light field projector device of claim 6, wherein at least one microlens in the microlens array has unique properties depending on its position in the microlens array.

8. The light field projector device of claim 1, further comprising, between the pixel forming device and the display lens, a reprojection optical component for:
receiving the plurality of elemental images;
refocusing the plurality of light rays from each of the plurality of elemental images; and
redirecting each of the plurality of light rays at a redirection angle.

9. The light field projector device of claim 8, wherein the redirection angle is uniform for the plurality of light rays within a single elemental image.

10. The light field projector device of claim 8, wherein the redirection angle is unique to each elemental image.

11. The light field projector device of claim 8, wherein the reprojection optical component is metalens, at least one lens, or a combination thereof.

12. The light field projector device of claim 1, wherein each of the plurality of hogels has an apparent hogel center shifted outward an offset distance from an actual hogel center to the edge of the display lens based on a location of the hogel relative to a center of the light field projector device.

13. The light field projector device of claim 12, wherein the offset distance increases as a function of the redirection angle.

14. The light field projector device of claim 12, further comprising, a hogel position shifting optical element positioned downstream from the hogel defining element to receive the plurality of hogels from the hogel defining element and configured to further shift the apparent hogel center of each hogel as perceived by a viewer to create a light field.

15. The light field projector device of claim 14, wherein the hogel position shifting optical element comprises one or more lenses.

16. A light field projector device comprising:
a light source;
a projection optical system to receive light from the light source and direct the light into a single ray path; and
a light field optical system comprising:
a pixel forming device to generate light in a pixel array creating a plurality of elemental images, each elemental image comprising a plurality of light rays;
a reprojection optical component for:
receiving the plurality of elemental images;
refocusing the plurality of light rays from each elemental image; and
redirecting each of the plurality of light rays at a redirection angle; and
a display lens for receiving the plurality of redirected light rays and defining a plurality of hogels, each of the plurality of hogels having an associated elemental image, an actual hogel center and an apparent hogel center, and creating a light field.

17. A method for generating a light field image, the method comprising:
creating a light field image at a plurality of light field projector devices by:
generating light with a light source;
directing the light from the light source into a single ray path;
pixelating the light at a pixel forming device to convert the light into a pixel array comprising a plurality of elemental images, each elemental image comprising a plurality of light rays;
refocusing the plurality of light rays from each elemental image;
redirecting each of the plurality of light rays at a redirection angle; and
receiving the plurality of redirected light rays at a display lens to define a plurality of hogels, each hogel having an associated elemental image and an actual hogel center, and creating a light field; and
tiling the light fields created by the plurality of light field projectors to provide a tiled light field image.

18. The method of claim 17, wherein the redirection angle is larger for hogels closer to an edge of the display lens.

19. The method of claim 18, wherein larger redirection angles for hogels closer to the edge of the display lens create an apparent hogel center, shifted outward an offset distance from the actual hogel center to the edge of each projector device, enabling controlled magnification of the light emitted from each projector which forms the light field to generate a seamless tiled light field image between the light field projector devices.

20. A light field projector device comprising:
a light source;
a projection optical system to receive light from the light source and direct the light into a single ray path; and
a light field optical system comprising:
a pixel forming device to receive light from the projection optical system and convert the light into a pixel array to create a plurality of elemental images; and
a hogel defining element for creating a plurality of hogels from the plurality of elemental images, each hogel having an associated elemental image, and creating a light field.

21. The light field projector device of claim 20, wherein the hogel defining element comprises a microlens array, a metalens, at least one lens, or a combination thereof.

22. The light field projector device of claim 20, wherein each of the plurality of hogels has an apparent hogel center shifted outward an offset distance from an actual hogel center toward an edge of the hogel defining element.

23. The light field projector device of claim 20, wherein the hogel defining element enables seamless tiling between multiple light field projector devices by generating apparent hogel centers to cover mechanical gaps between projector devices.

24. A method for creating a light field display comprising:
generating elemental images by converting light rays into a pixel array at a pixel forming device;
creating hogels from the elemental images using a hogel defining element, each hogel having an actual hogel center; and
for at least some of the hogels, shifting an apparent hogel center outward an offset distance from the actual hogel center to the edge of the hogel defining element.

25. The method of claim 24, further comprising maintaining substantially normal light input to the hogel defining element while achieving apparent hogel centers shifted outward an offset distance from the actual hogel center to the edge of the hogel defining element.

26. A light field display system comprising:
a plurality of tiled light field projector devices, each of the plurality of light field projector devices comprising:
a light source;
a projection optical system to receive light from the light source and direct the light into a single ray path; and
a light field optical system comprising:
a pixel forming device to receive light from the projection optical system and convert the light into a pixel array to create a plurality of elemental images, each elemental image comprising a plurality of light rays; and
a hogel defining element for receiving the light rays from each of the plurality of elemental images, defining a plurality of hogels, each hogel having an associated elemental image, and creating a light field.

27. The light field display system of claim 26, wherein the plurality of light field projector devices are tiled to form one of an asymmetric wall display, a curved wall display, a tabletop display, a horizontally mounted display unit, a tiled floor display, and a tiled wall with floor display.

28. The light field display system of claim 26, wherein the plurality of light field projector devices are positioned at varying angles relative to each other to form the curved wall display.

29. The light field display system of claim 26, further comprising a mounting system configured to arrange the plurality of light field projector devices in multiple display configurations.

30. The light field display system of claim 29, wherein the multiple display configurations comprise one or more of asymmetric arrangements, curved arrangements, varying orientations, floor configurations, and combined wall-floor configurations.

31. The light field display system of claim 29, wherein the mounting system allows reconfiguration between different display types without modification of individual projector devices.

32. A method for creating a light field display comprising:
providing a plurality of light field projector devices, each projector device comprising:
a light source;
a pixel forming device to generate a plurality of elemental images; and
a hogel defining element for receiving light from the pixel forming device and creating hogels from the elemental images, each elemental image comprising a plurality of light rays;
arranging the plurality of light field projector devices in a tiled configuration; and
calibrating the hogel defining elements to provide seamless tiling across the tiled configuration.

33. The method of claim 32, wherein the hogel defining element comprises a display lens.

34. The method of claim 32, wherein the hogel defining element redirects the plurality of light rays from each elemental image at a redirection angle to generate hogels having an apparent hogel center offset from an actual hogel center.

35. The method of claim 34, wherein the apparent hogel center is shifted outward an offset distance from the actual hogel center toward an edge of the hogel defining element.

36. The method of claim 34, wherein the redirection angle varies based on a position of the hogel within the hogel defining element.

37. The method of any claim 32, wherein the tiled configuration is one of a symmetric wall configuration, an asymmetric wall configuration, a curved wall configuration, a tabletop configuration, a horizontal mounting configuration, a tiled floor configuration, and a tiled wall with floor configuration.
